(19) United States
(12) Patent Application Publication
(10) Pub. No.: US 2019/0095879 A1
(43) Pub. Date: Mar. 28, 2019

(54) BLOCKCHAIN PAYMENT CHANNELS WITH TRUSTED EXECUTION ENVIRONMENTS

(71) Applicants: Cornell University, Ithaca, NY (US); Imperial College London, London (GB)

(72) Inventors: Ittay Eyal, Haifa (IL); Emin Gun Sirer, Ithaca, NY (US); Peter Robert Pietzuch, London (GB); Joshua David Lind, Andover (GB)

(21) Appl. No.: 16/100,689

(22) Filed: Aug. 10, 2018

Related U.S. Application Data
(60) Provisional application No. 62/563,420, filed on Sep. 26, 2017.

(51) Int. Cl. G06Q 20/06; G06Q 20/38

(52) U.S. Cl. CPC G06Q 20/065; G06Q 2220/00; G06Q 20/3829

(57) ABSTRACT

An apparatus in one embodiment includes a first processing device configured to communicate over a network with one or more additional processing devices including at least a second processing device. The first processing device includes a first blockchain client and a first trusted execution environment, and is configured to establish a first payment channel with a second trusted execution environment of the second processing device. The first processing device is also configured to associate at least one deposit with the first payment channel through execution of a corresponding blockchain transaction via the first blockchain client. The first processing device is further configured to utilize the deposit associated with the first payment channel to carry out multiple off-blockchain transactions between the first processing device and at least the second processing device. The first payment channel in some embodiments is part of a chain of payment channels established between trusted execution environments of respective pairs of the processing devices.

### PRIORITY CLAIM

The present application claims priority to U.S. Provisional Patent Application Ser. No. 62/563,420, filed Sep. 26, 2017 and entitled “Teechain: Payment Channels with Trusted Execution Environments,” which is incorporated by reference herein in its entirety.

### FIELD

The field relates generally to information security, and more particularly to techniques for implementing secure payment channels.

### BACKGROUND

Blockchain protocols such as Bitcoin are gaining traction for exchanging payments in a secure and decentralized manner. However, blockchain protocols are inherently limited in transaction throughput and latency. For example, their need to achieve consensus across a large number of participants fundamentally limits their achievable performance. Recent efforts to address performance and scale of blockchain protocols have focused on utilization of off-chain payment channels. While such payment channels can achieve low latency and high throughput, deploying them securely on top of the corresponding blockchain protocol has been difficult, at least in part because building a secure implementation often requires substantial changes to the underlying protocol.

### SUMMARY

Illustrative embodiments of the invention provide blockchain payment channels with trusted execution environments. These embodiments can advantageously achieve low latency and high throughput, in a given secure implementation, without the need for any substantial changes to the underlying protocol. A given blockchain payment channel in some embodiments is implemented as part of a chain of payment channels established between trusted execution environments of respective pairs of processing devices.

In one embodiment, an apparatus includes a first processing device comprising a processor coupled to a memory. The first processing device is configured to communicate over at least one network with one or more additional processing devices including at least a second processing device. The first processing device further comprises a first blockchain client and a first trusted execution environment. The first trusted execution environment is configured to establish a first payment channel with a second trusted execution environment of the second processing device. The first processing device is configured to associate at least one deposit with the first payment channel through execution of a corresponding blockchain transaction via the first blockchain client. The first processing device is further configured to utilize the deposit associated with the first payment channel to carry out multiple off-blockchain transactions between the first processing device and at least the second processing device.

The first payment channel in some embodiments is part of a chain of payment channels established between trusted execution environments of respective pairs of the processing devices including at least one additional payment channel established between the second trusted execution environment of the second processing device and an additional trusted execution environment of another one of the one or more additional processing devices.

Some embodiments are advantageously configured to provide a full-duplex payment channel framework that exploits trusted execution environments. Such embodiments can be deployed securely on the existing Bitcoin blockchain without having to modify the protocol. For example, a given embodiment of this type: (i) achieves a higher transaction throughput and lower transaction latency than prior solutions; (ii) enables unlimited full-duplex payments as long as the balance does not exceed the channel's credit; (iii) requires only a single message to be sent per payment in any direction; and (iv) places at most two transactions on the blockchain under any execution scenario.

Illustrative embodiments include high-performance micropayment protocols that support practical, secure, and efficient fund transfers on the current Bitcoin network. For example, some embodiments utilize multisignature time-locked transactions to establish long-lived payment channels between two mutually distrusting parties. An embodiment of this type fundamentally differs from existing protocols, however, in that it leverages trusted execution environments to strengthen the guarantees provided by the framework. For example, such an embodiment: (i) does not require any changes to the Bitcoin network; (ii) enables infinite channel reuse as long as the balance does not exceed the channel limits; and (iii) is both time-efficient and space-efficient, requiring only one-way messages for sending payments and two transactions to be placed on the blockchain in total.

Some embodiments provide improved off-chain payment protocols that utilize trusted execution environments to perform secure, efficient and scalable fund transfers on top of a blockchain, with asynchronous blockchain access. Such embodiments illustratively utilize secure payment chains to route payments across multiple payment channels. For example, a given embodiment of this type is configured to mitigate failures of trusted execution environments utilizing: (i) backups to persistent storage and (ii) chain replication. An example implementation using Intel Software Guard Extensions (SGX) as the trusted execution environment and the Bitcoin blockchain achieves orders of magnitude improvement in most metrics compared to conventional arrangements. One possible implementation of this type with replicated nodes in a trans-Atlantic deployment provides a measured throughput of over 33,000 transactions per second with about 0.1 second latency, although numerous alternative implementations are possible in other embodiments.

Although illustrative embodiments are described primarily in the context of Bitcoin or other blockchain-based payment transactions, the disclosed arrangements can be adapted in a straightforward manner for use with other types of payment transactions not necessarily involving blockchain.

These and other embodiments of the invention include but are not limited to systems, methods, apparatus, processing devices, integrated circuits, and processor-readable storage media having software program code embodied therein.

### BRIEF DESCRIPTION OF THE FIGURES

FIG. 1 shows an information processing system configured with functionality for implementing blockchain payment channels with trusted execution environments in an illustrative embodiment.

FIG. 2 illustrates an example of a blockchain payment channel implemented between a pair of user environments using respective trusted execution environments in an illustrative embodiment.

FIG. 3 is a signaling diagram showing a more detailed view of establishment, operation and settlement phases of a protocol for implementing the example blockchain payment channel of FIG. 2.

FIG. 4 illustrates an example of a chain of payment channels implemented between respective pairs of user environments via their respective trusted execution environments in an illustrative embodiment.

FIG. 5 is a signaling diagram showing a more detailed view of multiple phases of an example blockchain payment channel protocol involving trusted execution environments of four distinct user environments.

FIG. 6 illustrates the settling of a balance off-chain by moving the difference from one payment channel path to another.

FIG. 7 shows an information processing system with multiple geographically-distributed nodes configured to implement blockchain payment channels with trusted execution environments in an illustrative embodiment.

FIGS. 8A through 8F show example pseudocode for single-channel trusted execution in an illustrative embodiment.

FIGS. 9A through 9C show example pseudocode for trusted execution at a particular node in an illustrative embodiment.

### DETAILED DESCRIPTION

Embodiments of the invention can be implemented, for example, in the form of information processing systems comprising computer networks or other arrangements of networks, clients, servers, processing devices and other components. Illustrative embodiments of such systems will be described in detail herein. It should be understood, however, that embodiments of the invention are more generally applicable to a wide variety of other types of information processing systems and associated networks, clients, servers, processing devices or other components. Accordingly, the term “information processing system” as used herein is intended to be broadly construed so as to encompass these and other arrangements.

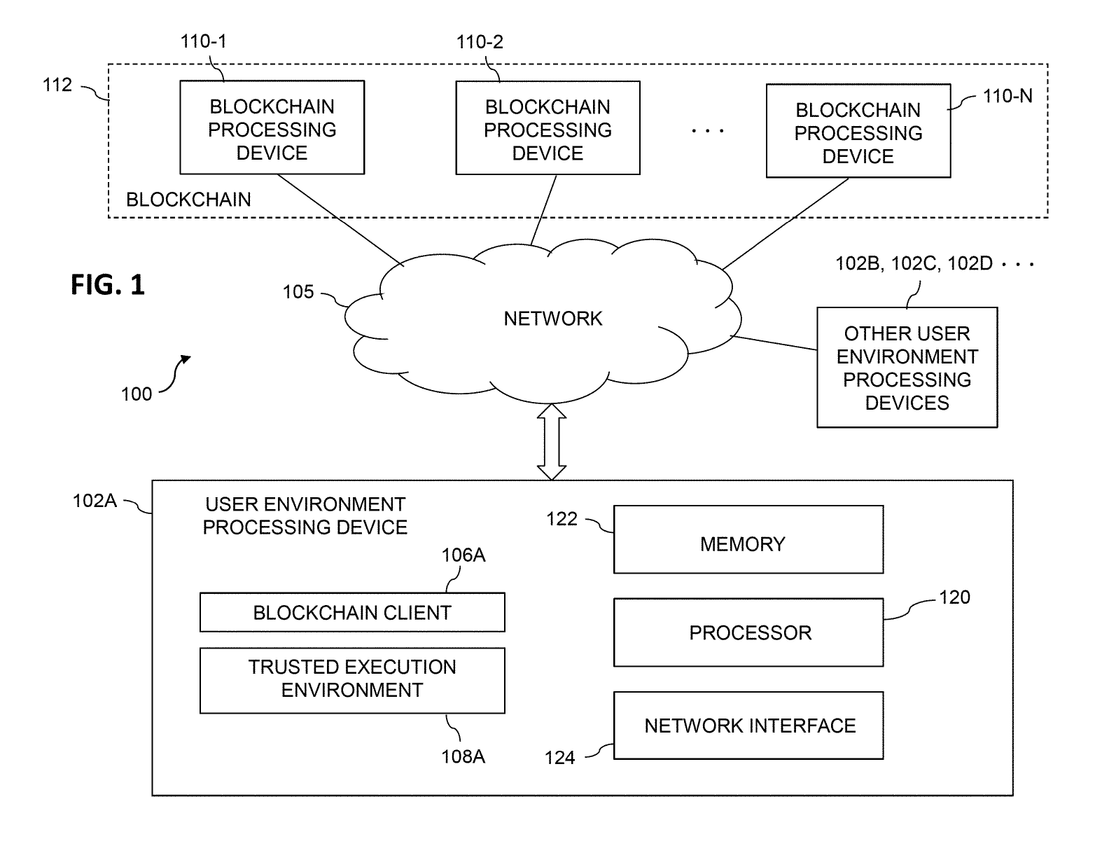

FIG. 1 shows an information processing system 100 implementing blockchain payment channels with trusted execution environments in an illustrative embodiment. The system 100 comprises a plurality of user environment processing devices 102A, 102B, 102C, 102D, etc. The user environment processing devices 102 are configured to communicate over a network 105. A given one of the user environmental processing devices 102A comprises a blockchain client 106A and a trusted execution environment 108A.

Also coupled to the network 105 are blockchain processing devices 110-1, 110-2, . . . 110-N that are associated with a blockchain 112. At least a subset of the user environment processing devices 102 may also comprise respective blockchain processing devices associated with blockchain 112.

The blockchain 112 in some embodiments comprises the Bitcoin blockchain collectively maintained by the blockchain processing devices 110, although other types of blockchains, such as the Ethereum blockchain or other types of cryptocurrency blockchains, can be used in other embodiments. The term “blockchain” as used herein is intended to be broadly construed so as to encompass distributed ledgers and other similar arrangements that are collectively maintained by multiple processing devices performing cryptographic operations involving interrelated data blocks.

Blockchains as used in embodiments herein can therefore include, for example, “permissionless” or public blockchains such as Bitcoin and Ethereum in which any user can participate in building consensus for validation of blockchain transactions, as well as “permissioned” or private blockchains in which only restricted sets of users can participate in building consensus for validation of blockchain transactions.

A given blockchain in some embodiments can comprise one or more smart contract programs. Such a smart contract program of a blockchain may itself comprise multiple separate programs.

Other embodiments can be configured to utilize payment channels of the type disclosed herein to process payments or other transactions not involving blockchain.

Each of the user environment processing devices 102 is assumed to be configured in a similar manner. As noted above, the user environment processing device 102A comprises a blockchain client 106A and a trusted execution environment 108A. Each of the other user environment processing devices 102B, 102C, 102D, etc. is assumed to include corresponding instances of these components.

The trusted execution environment 108A in some embodiments comprises an Intel SGX-based secure enclave. SGX comprises a set of instructions that confer hardware protections on user-level code, as described in, for example, Intel Corporation, “Intel® Software Guard Extensions Programming Reference,” 329298-002, US edition, 2014; “Intel® Software Guard Extensions Evaluation SDK User's Guide for Windows OS,” 2015; and “Intel® Software Guard Extensions SDK,” 2015. See also V. Costan et al., “Intel sgx explained,” Cryptology ePrint Archive, Report 2016/086, 2016. SGX enables process execution in a protected address space known as an enclave. The enclave protects the confidentiality and integrity of the process from certain forms of hardware attack and other software on the same host, including the operating system.

For example, an SGX-based secure enclave isolates code and data using hardware mechanisms in the CPU. Assuming the physical CPU package is not breached, SGX-based secure enclaves are protected from an attacker with physical access to the machine, including access to the memory, the system bus, BIOS, and peripherals.

A given one of the user environment processing devices 102 of system 100 in some embodiments is configured to execute one or more sets of process code associated with payment channel functionality in an SGX-based secure enclave of its corresponding trusted execution environment 108A.

Such an arrangement protects the given user environment processing device against malicious processes as well as the host operating system, and can allow the processing device to attest to a remote client that the client is interacting with a legitimate, SGX-backed instance of the process code.

During execution, enclave code and data reside in a region of protected memory called the enclave page cache (EPC). When enclave code and data is resident on-chip, it is guarded by CPU access controls; when it is flushed to DRAM or disk, it is encrypted. A memory encryption engine encrypts and decrypts cache lines in the EPC as they are written to and fetched from DRAM. Enclave memory is also integrity-protected, ensuring that modifications and rollbacks can be detected, and the enclave can terminate execution. Only code executing inside the enclave is permitted to access the EPC. Enclave code can, however, access all memory outside the enclave directly. As enclave code is always executed in user mode, any interaction with the host OS through system calls, e.g., for network or disk I/O, must execute outside the enclave. Invocations of the enclave code can only be performed through well-defined entry points under the control of the application programmer.

In addition, SGX supports remote attestation, which enables an enclave to acquire a signed statement from the CPU that it is executing a particular enclave with a given hash of memory, known as a quote. A third-party attestation service, e.g., as provided by the Intel Attestation Service (IAS), can certify that these signed statements originate from authentic CPUs conforming to the SGX specification.

It is to be appreciated that illustrative embodiments are not limited to use of the above-described SGX-based secure enclaves. For example, the trusted execution environment 108A can be implemented as another type of trusted execution environment, such as an ARM TrustZone trusted execution environment. The term “trusted execution environment” as used herein is therefore intended to be broadly construed.

One or more of the processing devices 102 and 110 of the FIG. 1 embodiment can each comprise, for example, a laptop computer, tablet computer or desktop personal computer, a mobile telephone, or another type of computer or communication device, as well as combinations of multiple such devices.

Communications between the various elements of system 100 are assumed to take place over one or more networks collectively represented by network 105 in the figure. The network 105 can illustratively include, for example, a global computer network such as the Internet, a wide area network (WAN), a local area network (LAN), a satellite network, a telephone or cable network, a cellular network, a wireless network implemented using a wireless protocol such as WiFi or WiMAX, or various portions or combinations of these and other types of communication networks.

The user environment processing device 102A in the present embodiment further comprises a processor 120, a memory 122 and a network interface 124. The processor 120 is assumed to be operatively coupled to the memory 122 and to the network interface 124 although such interconnections are not explicitly shown in the figure.

The processor 120 may comprise, for example, a microprocessor, an application-specific integrated circuit (ASIC), a field-programmable gate array (FPGA), a central processing unit (CPU), an arithmetic logic unit (ALU), a graphics processing unit (GPU), a digital signal processor (DSP), or other similar processing device component, as well as other types and arrangements of processing circuitry, in any combination.

The memory 122 stores software program code for execution by the processor 120 in implementing portions of the functionality of the processing device. For example, at least portions of the functionality of blockchain client 106A and trusted execution environment 108A can be implemented using program code stored in memory 122.

A given such memory that stores such program code for execution by a corresponding processor is an example of what is more generally referred to herein as a processor-readable storage medium having program code embodied therein, and may comprise, for example, electronic memory such as SRAM, DRAM or other types of random access memory, read-only memory (ROM), flash memory, magnetic memory, optical memory, or other types of storage devices in any combination.

Articles of manufacture comprising such processor-readable storage media are considered embodiments of the invention. The term “article of manufacture” as used herein should be understood to exclude transitory, propagating signals.

Other types of computer program products comprising processor-readable storage media can be implemented in other embodiments.

In addition, embodiments of the invention may be implemented in the form of integrated circuits comprising processing circuitry configured to implement processing operations associated with one or both of the blockchain client 106A and the trusted execution environment 108A as well as other related functionality.

The network interface 124 is configured to allow the user environment processing device 102A to communicate over the network 105 with other system elements, and may comprise one or more conventional transceivers.

In operation, a first one of the user environment processing devices 102, illustratively the processing device 102A, interacts with at least a second one of the user environment processing devices 102, illustratively the processing device 102B, in establishing a payment channel of the type disclosed herein. More particularly, the trusted execution environment 108A of the first processing device 102A is configured to establish a first payment channel with a second trusted execution environment of the second processing device 102B. The first processing device 102A is configured to associate at least one deposit with the first payment channel through execution of a corresponding blockchain transaction via the first blockchain client 106A. The first processing device 102A is further configured to utilize the deposit associated with the first payment channel to carry out multiple off-blockchain transactions between the first processing device 102A and at least the second processing device 102B. The multiple off-blockchain transactions can include transactions between the first processing device 102A and each of one or more other ones of the processing devices 102.

The trusted execution environments of the user environment processing devices 102 are also referred to herein as respective TEEs.

In some embodiments, the first payment channel comprises a bidirectional payment channel, although the term “payment channel” as used herein is intended to be broadly construed and should not be viewed as limited to bidirectional payment channels.

The blockchain transaction utilized to associate the deposit with the first payment channel is illustratively configured to associate a designated amount of cryptocurrency with a first cryptocurrency address of the first trusted execution environment 108A of the first processing device 102A. The first trusted execution environment 108A securely maintains a private key for the cryptocurrency address.

The first trusted execution environment 108A interacts with the second trusted execution environment of the second processing device 102B in order to securely maintain channel state information for the first payment channel.

The first processing device 102A is illustratively configured to terminate the first payment channel at a particular point in time in accordance with its current channel state. Responsive to the termination of the first payment channel, any channel balance is settled through execution of a corresponding blockchain transaction via the first blockchain client 106A.

In carrying out a given one of the multiple off-blockchain transactions between the first processing device 102A and the second processing device 102B, the first payment channel is first locked, a protocol is then executed for the first and second processing devices to reach consensus regarding an updated balance for the first payment channel, and then the first payment channel is unlocked with the updated balance.

As will be described in more detail below, the first payment channel in some embodiments is part of a chain of payment channels established between trusted execution environments of respective pairs of the processing devices 102 including at least one additional payment channel established between the second trusted execution environment of the second processing device 102B and an additional trusted execution environment of another one of the one or more additional processing devices 102.

For example, the deposit associated with the first payment channel may be utilized to carry out a given one of the multiple off-blockchain transactions between the first processing device and an n-th one of the processing devices via at least the second processing device, where n is greater than two, and wherein the chain of payment channels comprises n−1 payment channels including the first payment channel.

Carrying out the given one of the multiple off-blockchain transactions between the first processing device and the n-th processing device via at least the second processing device illustratively further comprises locking the payment channels of the chain of payment channels between the first processing device and the n-th processing device, executing a protocol for the n processing devices to reach consensus regarding updated balances for respective ones of the payment channels, and then unlocking the payment channels with their respective updated balances.

It is be appreciated that the particular arrangement of components and other system elements shown in FIG. 1 is presented by way of illustrative example only, and numerous alternative embodiments are possible. For example, one or more of the user environment processing devices 102 and blockchain processing devices 110 can each comprise additional or alternative components, such as a cryptocurrency wallet utilized in conjunction with making or receiving cryptocurrency payments associated with a payment channel. Also, as noted above, a given processing device of system 100 can be both a user environment processing device and a blockchain processing device.

It should also be noted that illustrative embodiments are not limited to use with blockchains or cryptocurrencies. For example, payment channels of the type disclosed herein can be adapted in a straightforward manner for use with a wide variety of other types of payment transactions, including financial transactions associated with the Society for Worldwide Interbank Financial Telecommunication (SWIFT) network.

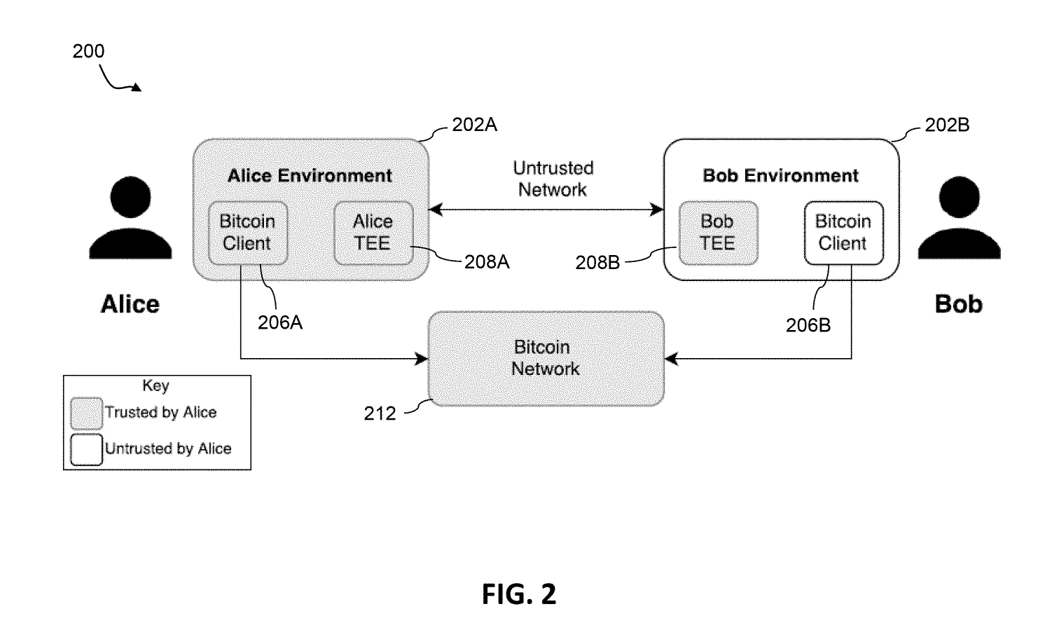

Additional aspects of illustrative embodiments will be described in greater detail below with reference to FIGS. 2 through 9. These embodiments include a first protocol referred to herein as “Teechan” and a second protocol referred to as “Teechain.” These are both considered illustrative embodiments, and so the particular details of these implementations as described below should not be construed as limiting in any way. Both Teechan and Teechain can also be viewed as more detailed implementations of the payment channel processing arrangements of system 100 as described previously.

These illustrative embodiments are described in the context of the Bitcoin blockchain, but as indicated previously are applicable to other types of blockchains. The Nakamoto consensus protocol that underpins Bitcoin is fundamentally limited in transaction throughput and imposes a significant minimum transaction latency. Furthermore, since miners must store the history of every transaction ever made, accumulating storage costs increase the cost of running nodes, which, in turn, leads to centralization pressure.

The maximum transaction throughput of Bitcoin is determined by the block size and the block interval. With a block size of 1 MB and an average block interval of 10 minutes, Bitcoin can support a maximum of 7 transactions per second (tx/s). Recent proposals have suggested either tuning these parameters, such as increasing the block size or reducing the block interval; or modifying the protocol, for example, by incrementally creating blocks so as to avoid centralization bottlenecks and increase throughput. The former approach cannot scale Bitcoin by more than one order of magnitude, while the latter requires changes to the underlying protocol, which practitioners have been reticent to make. Other research suggests that hardware limits, such as the cost of signature verification and storage latencies, cap Bitcoin to 200 tx/s.

To handle demanding workloads, such as credit card processing (≥10,000 tx/s), recent proposals have focused on moving transactions off the blockchain through the use of point-to-point payment channels. Payment channels allow for efficient, trustless fund transfers, in which parties can exchange transactions without having to impact the blockchain except when the channel is established or terminated. Consequently, two parties can engage in a large number of fund transfers, only settling the net result on the blockchain. This decreases transaction confirmation latency, as only two entities are involved, and reduces the load on the blockchain and network, such that throughput scales linearly with the number of channels.

Despite the advantages of bidirectional payment channels, none have been deployed securely on the existing Bitcoin network, as conventional approaches assume modifications to the underlying protocol. For example, some conventional approaches require transaction IDs to be set before the transaction IDs are signed.

The Teechan embodiment to be described below provides a full-duplex payment channel framework that exploits trusted execution environments, also referred to as TEEs in the following description. Teechan can be deployed securely on the existing Bitcoin blockchain without having to modify the protocol. Teechan: (i) achieves a higher transaction throughput and lower transaction latency than prior solutions; (ii) enables unlimited full-duplex payments as long as the balance does not exceed the channel's credit; (iii) requires only a single message to be sent per payment in any direction; and (iv) places at most two transactions on the blockchain under any execution scenario.

We have built and deployed an example prototype implementation of the Teechan framework using Intel SGX on the Bitcoin network. Our experiments show that, not counting network latencies, Teechan can achieve 2,480 transactions per second on a single channel, with sub-millisecond latencies.

Teechan advantageously provides a high-performance micropayment protocol that supports practical, secure, and efficient fund transfers on the current Bitcoin network. Teechan uses multi signature (“multisig”) time-locked transactions to establish long-lived payment channels between two mutually distrusting parties. It fundamentally differs from existing protocols, however, in that it leverages TEEs to strengthen the guarantees provided by the framework: (i) Teechan does not require any changes to the Bitcoin network; (ii) it enables infinite channel reuse as long as the balance does not exceed the channel limits; and (iii) it is both time-efficient and space-efficient, requiring only one-way messages for sending payments and two transactions to be placed on the blockchain in total.

At a high level, current implementations of TEEs can provide confidentiality and integrity guarantees for code and data, but cannot guarantee liveness or safe termination for a protocol. Teechan is designed in a manner that, despite these limitations, no party can gain access to more funds than their current net balance. In particular, the TEE ensures that the private keys that control the channel are never exposed to untrusted software or hardware, ruling out a large class of potential attacks. These guarantees are robust in the presence of compromised privileged software, such as the operating system, hypervisor, and BIOS. In addition, an attacker who has full control of the hardware outside of the CPU package, including the RAM, the system bus and the network, cannot violate our security guarantees.

The Teechan embodiment to be described in further detail below provides a practical framework for low-latency, high-throughput, secure off-chain Bitcoin transactions between mutually-distrusting parties. The description to follow includes the detailed operation of a prototype implementation of this framework using Intel SGX as the TEE. In addition, it presents preliminary performance measurements from our prototype implementation, demonstrating that Teechan can achieve 2,480 tx/s on a single payment channel, thereby enabling system-wide aggregate throughput that can compete with and surpass the requirements of credit card payment networks.

We first provide a short overview of Bitcoin, and describe why it is unable to scale absent utilization of the payment channel techniques disclosed herein.

Bitcoin is a digital cryptocurrency that allows users to keep and exchange funds. In Bitcoin, each user is identified by a public Bitcoin address that is associated with a public/private key pair that is kept by the user. Bitcoin users exchange funds by issuing public Bitcoin transactions, i.e. pieces of information conveying which funds are to be transferred between which Bitcoin addresses.

Bitcoin is implemented in the form of a distributed peer-to-peer network that executes a replicated state machine. Each peer, or node, in the network maintains and updates a copy of the Bitcoin blockchain, an append-only log that contains the transaction history of every account in the network. Users interact with the network by issuing transactions to transfer Bitcoins, also denoted as BTC in some description herein. Valid transactions consume unspent transactions as inputs and create new unspent outputs that can later be used in a new transaction. To spend an unspent output, a condition specified by a locking script must be met. Typically, a signature matching an address proves that the user spending the output owns the account claiming the funds. More complex locking scripts can be expressed, such as m-of-n multisig transactions, where m signatures are required out of n possible signatures to spend the funds; and timelocked transactions, which can only be spent after a point in the future.

More particularly, each transaction on the Bitcoin blockchain consists of transaction inputs and transaction outputs. Transaction inputs are unspent transaction outputs (UTXOs), i.e. outputs of previous transactions that have not yet been spent. As a consequence, valid transactions consume, or spend, existing UTXOs as inputs and create new UTXOs that can later be used in new transactions. To use an UTXO as a transaction input, i.e. to spend the UTXO, the spending user must meet a condition expressed as a script that is specified within each UTXO. Typically, this script specifies that the spender must present a signature that matches a certain Bitcoin address, thus proving ownership of the UTXO (this is often termed “pay-to-public-key-hash” or P2PKH). Illustrative embodiments to be described herein utilize P2PKH scripts, but more complex scripts could be used in other embodiments. All nodes maintain a copy of the Bitcoin blockchain and verify that all issued transactions are valid, i.e., only spend UTXOs and satisfy all scripts' conditions.

Transactions are appended to the Bitcoin ledger in batches known as blocks. Each block includes a unique ID, and the ID of the preceding block, forming a chain. Peers in the network compete to generate and append these blocks to the blockchain. This process, known as mining, is computationally expensive and requires solving a cryptographic puzzle. Miners are compensated for their efforts via the block reward as well as the transaction fees collected from the transactions in that block. The Bitcoin protocol dynamically adjusts the difficulty of the cryptographic puzzle so that a block is appended to the blockchain at an average rate of one block every ten minutes. In cases in which there are multiple blocks with the same parent (forks), the network adopts the chain with the greatest difficulty.

This Bitcoin protocol architecture protects against double spend attacks. In such an attack, two conflicting transactions claim the same unspent outputs. The Bitcoin protocol will ensure that the miners will mine at most one of these transactions, and clients of the network will wait for additional succeeding blocks (typically, six blocks) to guard against forks and reorganizations.

Overall, the Bitcoin protocol suffers from two fundamental limitations. First, because it limits the size of each block and the rate of block generation, the network is fundamentally limited in throughput. Second, because the suffix of the blockchain is subject to reorganization, users typically must wait until their transactions are buried sufficiently deeply, incurring a minimum latency.

As will be described in detail below, these fundamental limitations of the Bitcoin protocol are advantageously overcome in illustrative embodiments through the use of payment channels of the type disclosed herein.

There are a wide variety of blockchain protocols other than Bitcoin. For example, a vibrant cryptocurrency community has emerged to develop hundreds of public, blockchain-based, cryptocurrencies. In addition, companies and organizations in the financial technology (FinTech) industry are looking to develop blockchain protocols, referred to as Distributed Ledger Technology, for bank-to-bank transactions.

The participants in a blockchain maintain a log of the systems' transactions and reach distributed consensus on their order with a high degree of replication to overcome node failure and attacks. While this approach is responsible for the security and reliability of blockchain protocols, it is also responsible for their greatest weakness: performance is limited by the rate and latency that it takes for nodes to reach consensus.

The increasing adoption of blockchain protocols for both cryptocurrencies and FinTech requires support for drastically higher performance. For cryptocurrencies in particular, adoption has grown rapidly and this has raised a critical concern: can the technology that is currently limited to a handful of transactions per second (tx/sec), and takes minutes to process a transaction, achieve the performance required for credit card processing workloads, i.e. can blockchain based cryptocurrencies confirm transactions in seconds and accommodate throughput of tens of thousands of tx/sec? Illustrative embodiments disclosed herein can in fact achieve these levels of performance.

In some embodiments, payment channels are configured for use between two parties that have long-lived financial relationships that require frequent interaction with high-throughput, low latency, and privacy guarantees.

For example, the Teechan embodiment constructs a duplex payment channel between two such endpoints, assuming that these endpoints are equipped with TEEs. Payment channels can be established between other types of parties in other embodiments.

The Teechan embodiment illustratively utilizes a threat model that assumes that both parties wish to exchange funds but mutually distrust one another. Each party is potentially malicious, i.e., they may attempt to steal funds, avoid making payments, and deviate from the agreement if it benefits them. Any time during channel establishment, execution, and closure, each party may drop, send, record, modify, and replay arbitrary messages in the protocol. Either party may terminate the channel at any time. Also, failures are possible.

We assume that each party has a TEE-capable machine and trusts the Bitcoin blockchain, its own environment, the local and remote TEEs, and the code that executes the Teechan duplex channel protocol. The rest of the system, such as the network between the parties and the other party's software stacks (outside the TEE) and hardware are untrusted. During protocol execution, any party may therefore: (i) access or modify any data in its memory or stored on disk; (ii) view or modify its application code; and (iii) control any aspect of its OS and other privileged software.

Our threat model in the present embodiment does not take into account denial-of-service attacks or side-channel attacks. In practice, these are difficult to exploit, and can be mitigated, as will be appreciated by those skilled in the art. Alternative threat models can be used in other embodiments.

A payment channel in illustrative embodiments is configured to operate as follows. A channel is established with a setup transaction in the blockchain to which each party deposits an amount as credit. While the channel is open, each party can pay its counterparty via transaction messages sent from the payer to the payee. A payment can only be claimed if it was granted by a party, that is, theft should not be possible. At any point in time, the channel has a balance that must reflect the difference between the amounts paid in each direction. The balance should never exceed the credit in either direction. Either party can terminate the channel at any time and settle the balance with a terminating transaction that it places in the blockchain. The terminating transaction reflects a balance that comprises all payments made by the terminator and all payments received by the terminator from its counterparty. Failures should only negatively impact the party who failed.

Parties should only need to synchronize with the Bitcoin network during channel establishment and at the point of settlement. In particular, they should not need to monitor the blockchain during the lifetime of the channel.

Teechan is configured to exploit TEEs to act as a trusted third party between two parties, also referred to herein as Alice and Bob.

At a high level, Teechan operates as follows. First, at setup, the TEE at each party is securely given mutual secrets belonging to both parties. These secrets can be used at any time to settle the channel, without needing cooperation. Next, while the channel is open, the TEEs maintain channel state internally, free from tampering due to the guarantees of trusted execution. Updates (payments) are performed through a secure interface. Finally, Teechan leverages secure execution to settle the channel at termination. Only on termination does a TEE generate a Bitcoin transaction that can be placed in the blockchain.

Unlike conventional approaches, Teechan does not make a settlement transaction available until channel termination. The availability of such a transaction is the root cause behind much of the complexity of conventional payment channel implementations: it causes race conditions, requires a timely response when leaked to the network prematurely, and requires additional infrastructure for monitoring. This factoring of crucial channel functionality into TEEs yields a simple and efficient approach.

FIG. 2 shows an example of the above-described blockchain payment channel implemented in an information processing system 200 between a pair of user environment processing devices 202A and 202B associated with the respective system users Alice and Bob. The processing device 202A of Alice comprises a Bitcoin client 206A and a TEE 208A. Similarly, the processing device 202B of Bob comprises a Bitcoin client 206B and a TEE 208B. The Bitcoin clients 206A and 206B interact via a Bitcoin network 212. The TEEs 208A and 208B interact via an untrusted network. Numerous alternatives to the Bitcoin blockchain can be used in other embodiments.

In this example of the Teechan duplex payment channel architecture, both Alice and Bob run their own TEEs alongside a connection to the Bitcoin network 212. This connection to the Bitcoin network 212 is illustratively only used during channel establishment and closure. The figure highlights the entities trusted by Alice. An identical figure can be constructed for Bob using symmetry of the channel.

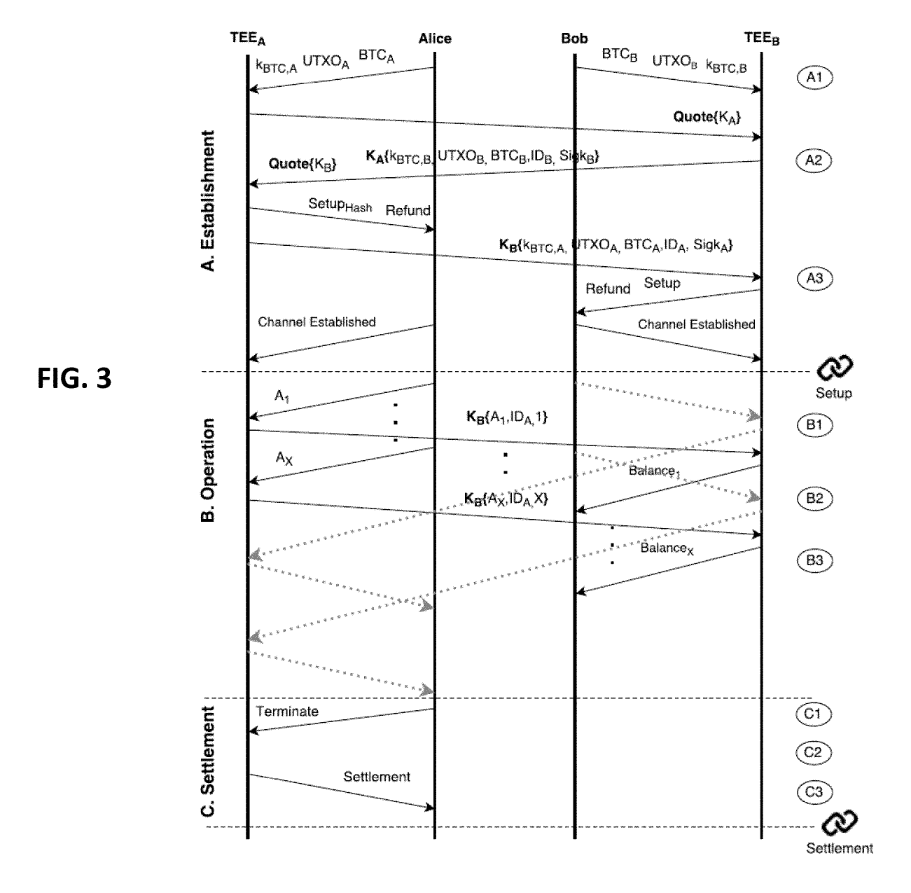

FIG. 3 shows the Teechan protocol of this embodiment in more detail. More particularly, this figure illustrates signal flow between the processing devices 202A and 202B and their respective TEEs 208A and 208B. The signal flow in this embodiment includes multiple distinct phases of the Teechan protocol for implementing the example blockchain payment channel illustrated in FIG. 2.

The Teechan protocol in this embodiment operates in three phases: (i) channel establishment, (ii) channel operation, and (iii) channel settlement. FIG. 3 shows the messages exchanged during each of these phases in detail. Alice, Bob, Alice's TEE (denoted TEE_{A}) and Bob's TEE (denoted TEE_{B}) are modeled as separate entities.

For simplicity, we ignore mining fees in our example, although they are supported in our implementation and affect only the initial setup and the final settlement transactions.

A. Channel establishment. In the first phase, Teechan establishes the duplex payment channel between Alice and Bob. Similar to prior work [18, 13, 33], we construct a payment channel using setup and refund transactions. Both Alice and Bob deposit funds into a 2-of-2 multisig Bitcoin address, forming a setup transaction. A refund transaction is constructed that spends the setup transaction and returns Alice and Bob's deposits back to them. The refund transaction is bounded by a lock-time using the nLockTime transaction field, making it valid only starting sometime in the future. The channel must be terminated prior to this time, otherwise either party can terminate the channel as if no transactions took place.

A1. First, Alice and Bob each provision their TEEs to construct setup and refund transactions. This requires: (i) their Bitcoin private keys, k_{BTC,A} and k_{BTC,B}; (ii) the unspent transactions outputs sets that they wish to include in the setup transaction, UTXO_{A} and UTXO_{B}; and (iii) the amount to deposit in the setup transaction, BTC_{A} and BTC_{B}.

A2. Second, TEE_{A} and TEE_{B} establish a secure communication channel, authenticating each other through remote attestation. To achieve this, each TEE generates an asymmetric encryption key pair and a random secret key using a secure random number generator. TEE_{A} binds the generated asymmetric public key to a quote, and sends it to Bob. Using this quote, Bob can then verify that any message encrypted under K_{A} can be decrypted solely by TEE_{A}, and that TEE_{A} is running the desired Teechan code with the requisite binary hash. The same is done in the reverse direction, so TEE_{A} obtains Bob's public key. Upon successful mutual verification, TEE_{A} and TEE_{B} know that any data encrypted under K_{A} and K_{B} can only be read by the opposite TEE. This establishes a confidential communication channel.

A3. TEE_{B} then presents its random secret key (denoted ID_{B}), along with Bob's setup data that it received in step A1, to TEE_{A}. A signature over this message, under the private key of TEE_{B} (denoted Sigk_{B}), is also presented to ensure that it came from TEE_{B}. TEE_{A} generates the signed setup and refund transactions internally, and reveals to Alice the hash of the setup transaction, denoted Setup_{Hash}, as well as the refund transaction. Only TEE_{A} knows the setup transaction at this point.

TEE_{A} then presents its random secret key ID_{A}, along with Alice's setup data that it received in step A1 and the corresponding signature Sigk_{A}, to TEE_{B}. TEE_{B} generates the setup and refund transactions internally, and reveals both to Bob. Bob then broadcasts the setup transaction onto the blockchain, establishing the channel. Alice is notified of channel establishment by noting a transaction matching Setup_{Hash} on the blockchain.

Note that Bob could maul the setup transaction before broadcasting it, making Alice's refund transaction invalid. In this case, Alice presents the mauled setup transaction to TEE_{A} to issue a new refund transaction that closes the channel immediately. This requires that keys should never be re-used between separate channels, as is already a recommended good practice. In Teechan, mauling the setup transaction is equivalent to a denial-of-service attack.

At the end of this three-step handshake, a secure communication channel is established between the two TEEs. The slight asymmetry of the handshake is critical for achieving the termination and loss properties described below.

B. Channel operation. Once a channel has been established between TEE_{A} and TEE_{B}, Alice and Bob can begin exchanging funds. In this phase, neither Alice nor Bob need to maintain a connection with the Bitcoin network. They can rapidly make transactions through peer-to-peer updates. Note that in FIG. 3, payments made from Bob to Alice are shown using dotted but unlabeled lines, for illustration purposes only. These payments exhibit the same behavior, in a symmetric fashion, to the payments sent from Alice to Bob.

B1. To send funds to Bob, Alice sends a request locally to TEE_{A}, specifying the amount of Bitcoin that she wishes to transfer to Bob. These requests are denoted A₁ through A_{X}, representing arbitrarily many payment requests.

B2. When a TEE receives a payment request from the owner, it first checks that the current balance is greater than the amount to send. If so, it updates the balance and generates a message authorizing the payment. The message contains the random secret key of the paying TEE ID_{A} and the updated monotonic counter value. The message is encrypted under the appropriate asymmetric public key K_{B}. Alice sends this message to Bob.

B3. Bob receives the message and sends it to TEE_{B}. Once the TEE receives the message, it decrypts it and asserts that it contains the correct secret key and that the value of the counter is greater by one than the previously presented counter. Then, it updates the balance and the counter for incoming messages. Finally, it notifies Bob of the new balance.

Note that each party, outside the TEE, is in charge of maintaining a reliable FIFO channel for the payment messages. This can be achieved with standard go-back-n or similar protocols. Tampering with the order of messages is equivalent to a denial-of-service attack on the recipient only; the sender always processes a payment. It is therefore in the best interest of the receiver to ensure a reliable FIFO channel.

C. Channel settlement. The final stage of the Teechan protocol is channel settlement. In this phase, the payment channel is closed, and a valid transaction settling the balance between Alice and Bob is broadcast to the Bitcoin network, thus releasing the funds in the setup transaction.

C1. At any point during phase B, either party may send a terminate request to their TEE.

C2. Once a TEE receives a terminate request from its owner, it generates a settlement transaction signed with k_{BTC,A} and k_{BTC,B}, which spends the funds held in the setup transaction according to the current channel balance. It returns this transaction to the host, destroys all state held in TEE memory and halts its execution.

C3. The party then forwards this to the Bitcoin network to complete the settlement.

Teechan payment channels in the present embodiment do not suffer from channel exhaustion. In addition, Teechan enables infinite channel reuse: Alice and Bob can send funds back and forth until channel timeout.

Termination of a channel at the end of its lifetime is implemented in a manner similar to conventional approaches. When the refund transaction becomes valid, either party can choose to broadcast the refund transaction, or to settle the current state of the channel, as described above. Whichever transaction is confirmed by the Bitcoin network dictates the outcome of the channel.

Note that a unilateral channel termination by Bob cannot harm Alice: he will not be able to receive further payments from Alice, but the closed channel will accurately reflect all payments of which Alice is aware. If Bob fails to broadcast the termination transaction to the Bitcoin network, Alice can independently close it from her side.

Teechan is not a consensus protocol, nor is it designed to solve the well-known Byzantine Generals Problem. Accordingly, Alice and Bob may not agree on the termination state, but Alice's termination state is guaranteed to be acceptable by Bob, and vice-versa.

In the following, we provide the intuition behind the security properties of the Teechan protocol described above.

Any time during channel establishment, execution and closure, each party may drop, send, record, modify, and replay arbitrary messages in the protocol. As such, we informally evaluate and describe the security of our protocol against malicious and misbehaving parties. Note that any external adversary in the system, such as an attacker who has compromised the network, has fewer privileges than the counterparty in the channel, and so can be subsumed by a malicious counterparty. Arguing security against the opposite party in a channel is strong enough to protect against any external adversary.

During channel establishment, each TEE is provisioned with sensitive setup data from both parties. This is always performed through a secure interface, encrypted with a key internal to the TEE. Communication with the counter party's TEE is only performed after verifying that it is indeed a TEE executing the Teechan code. Finally, no party can access the setup transaction before the other party has the refund transaction. Therefore, at the end of channel establishment both parties have the refund transaction and only the TEEs have both secrets.

During channel operation, once a party receives a payment, the sending party's TEE has already registered this payment. Therefore, and due to the counter encoded in each payment message, a party cannot revert a payment that it has made when settling the channel. Early termination can only prevent a party from receiving future payments, not harming the other party.

As mentioned previously, we implement Teechan on Intel SGX. Intel SGX provides secure TEEs having both execution integrity and confidentiality against an attacker on the same machine, even one with physical access. These hardware guarantees, coupled with Teechan's architecture, enable the resulting system to be resilient against an array of attacks. The tight integration of SGX with the CPU ensures that the cost to launch an attack, or even gather enough know-how to attempt one, are orders of magnitude higher than the value expected to be stored in payment channels. Given the current market share of Intel CPUs, users already implicitly trust a single hardware manufacturer with their secret keys. We repeat, however, that nothing in the Teechan protocol is Intel specific, and our protocol can be ported easily to, for example, a Ledger hardware security module, or other types of trusted execution environments.

Replay attacks are detrimental to Teechan security: if Alice could revert the system to an old state, she could take a snapshot when the balance is in her favor, and after sending payments to Bob, revert to that old state and settle the channel at a wrong balance. SGX protects running enclaves against replay attacks by protecting persistently stored snapshots from rollback attacks through non-volatile hardware monotonic counters, which prevent a stale enclave snapshot from being reused.

In an example Teechan prototype to be described below, if Alice fails, she can either ask Bob to settle at the current balance, or wait until the refund transaction becomes available. It is straightforward to extend the prototype such that the enclaves persist their state to secondary storage, encrypted under a key and stored with a non-replayable version number from the hardware monotonic counter. Our current implementation does not leverage hardware monotonic counters, because, while the counters are fully supported by the existing hardware under Windows, the current SGX Linux SDK does not expose them yet. Porting our protocol to Windows or support for monotonic counters in the Linux SDK can address this.

Currently, the validity of an Intel SGX attestation is certified through the above-noted IAS, which ensures that the quote originated from a genuine SGX-capable Intel CPU. In our prototype, we do not use a trusted connection between the enclave and the IAS; the quote is verified in untrusted code, executed by the owner of the enclave during the setup phase. This is benign because misbehavior by a party at this stage would only harm that party, as it would expose their private keys to a fraudulent remote enclave. Terminating the TLS connection to the IAS inside the enclave would avoid this issue, but it is unnecessary under our trust model and would needlessly increase the trusted computing base.

We evaluated Teechan using Intel SGX on the Bitcoin testnet. Our implementation is fully compatible with the standard Bitcoin network. We report preliminary measurements from this implementation to illustrate the range of achievable performance.

The above-noted Teechan prototype has two components: a Bitcoin client and an Intel SGX enclave application that executes the secure Teechan protocol. Each party in the payment channel maintains and executes their own client and enclave. For the Bitcoin client, we fork the open-source libbitcoin-explorer, a C++ Bitcoin library that communicates with the Bitcoin network. libbitcoin-explorer relays transactions and requests to a bitcoin-server, a full Bitcoin peer in the Bitcoin network. In our experiments, we use libbitcoin-explorer version 3.0.0 and communicate with a set of public-facing bitcoin-servers.

For the Teechan enclave application, we port a subset of Bitcoin Core version 0.13.1 to Intel SGX. Only some features of Bitcoin core are needed inside the enclave: (i) multisig address generation; (ii) transaction creation; (iii) transaction signing; and (iv) signature verification. For asymmetric encryption between enclaves, we use RSA with 4096-bit keys. Both libbitcoin-explorer and the Teechan enclave communicate over TCP using a lightweight message queuing library (ZeroMQ version 4.2.1).

To evaluate Teechan, we ran all experiments on a single machine, which forms a channel between two parties communicating through network sockets. We use an SGX-enabled 4-core Intel Xeon E3-1280 v5 at 3.7 GHz with 64 GB of RAM, and Ubuntu 14.04 with Linux kernel 3.19. We deactivate hyper-threading, compile the applications using GCC 5.4.0 with −02 optimizations and use the Intel SGX SDK 1.7.

We measured the time taken by Teechan to perform each of the three phases of the protocol. To measure the throughput, we emulate an exchange between two parties in which each party sends and receives payments sequentially in lock-step. We measure the time for 10 million transactions to be exchanged. These measurements yield an upper bound for our current implementation, as they eliminate network bandwidth and latency.

Channel establishment and final settlement times are bounded by the time to place the transactions in the blockchain. Once the channel is set up, we measure an average latency of 0.40 ms and an average throughput of 2480 tx/s.

For the purpose of demonstration, we provide a reference to a Teechan payment channel that was established, operated, and settled on the Bitcoin test network. Each side deposited 50 bitcoin in the setup transaction, and the channel was closed with a balance of 9 bitcoin for Bob. A fee of 0.002 bitcoin was paid on each transaction.

The illustrative embodiment of the Teechan protocol described above provides a number of significant advantages relative to conventional approaches. For example, in Teechan there is no limit on the total amount moving in any direction, and only two transactions are ever placed in the blockchain. Also, in Teechan a payment is done with a single message, and payments in both directions can be made concurrently, making it full-duplex rather than half-duplex. Additionally, on disagreement, only two transactions are placed in the blockchain. Furthermore, in Teechan, both parties can deposit into a Teechan channel, and neither party ever controls a transaction that reflects an old state.

As noted above, Teechan is an example of an arrangement providing full-duplex payment channels based on the existing Bitcoin network with TEEs. The Teechan prototype implementation, built on Intel SGX, can achieve 2,480 tx/s and a transaction latency of 0.40 ms in optimal conditions. It advances the state of the art by obviating the need to modify the underlying Bitcoin protocol for a practical deployment, improving channel performance, and reducing blockchain overhead.

Other illustrative embodiments of payment channels disclosed herein need not include the particular features and functionality described above in conjunction with the Teechan embodiments.

For example, another illustrative embodiment to be described below, referred to as Teechain, utilizes chains of payment channels.

The Teechain protocol is an off-chain payment protocol that utilizes TEEs to perform secure, efficient and scalable fund transfers on top of a blockchain, with asynchronous blockchain access. Teechain introduces secure payment chains to route payments across multiple payment channels. Teechain mitigates failures of TEEs with two strategies: (i) backups to persistent storage and (ii) a novel variant of chain-replication. We evaluate an implementation of Teechain using Intel SGX as the TEE and the operational Bitcoin blockchain. Our prototype achieves orders of magnitude improvement in most metrics compared to existing implementations of payment channels. For example, with replicated Teechain nodes in a trans-Atlantic deployment, we measure a throughput of over 33,000 transactions per second with 0.1 second latency. Conventional approaches to payment channels generally require synchronous access to the blockchain: at any time, a user can settle the channel by removing their balance from the payment channel and creating a transaction to be placed on the blockchain. Each party can also settle the channel at a deprecated state using a previous capability. To prevent such attacks, existing solutions require users to monitor the blockchain continuously and react to misbehavior, which places a burden on users.

In contrast to these conventional approaches, Teechain implements payment channels with asynchronous blockchain access. To achieve this, it departs from existing software-only solutions and leverages support for TEEs.

Teechain uses collateral for funds in the form of on-blockchain deposits to secure payment commitments on its channels. The collateral is maintained by the TEEs, allowing users to dynamically move funds between different payment channels. Because the TEEs protect the internal channel state and release it only upon channel termination, they ensure that users cannot launch attacks by using stale state. In turn, this construction avoids the common attacks on payment channels, simplifies the protocol, and improves performance.

The Teechain protocol utilizes payment chains, in which funds are transferred across a chain of channels, or hops, and is configured to ensure that either the payment completes successfully, or that all channels in the chain are settled consistently, either in pre-payment or post-payment state. This atomicity guarantee ensures that no coins are lost, double-spent or left in limbo despite failures along any of the nodes on a payment path.

Teechain also provides a strong fault tolerance guarantee, based on two separate techniques targeting users with different performance demands. For low-frequency users, such as individuals, Teechain exploits TEE support for hardware monotonic counters, and uses them to persist state to stable storage, while preventing replay attacks; for high-frequency payments, such as exchanges, Teechain implements a particularly advantageous chain replication arrangement configured to achieve high performance and provide fault tolerance as long as at least one TEE in the chain is available.

The experimental evaluation of our Teechain prototype implementation shows that Teechain performs significantly better than prior protocols in a WAN setting: channel bootstrapping and termination takes less than a second, rather than tens of minutes or hours with previous solutions; and Teechain exhibits both low latency and high throughput: the prototype implementation supports 33,000 tx/sec across the Atlantic.

As in the Teechan embodiment described above, we consider in the following description of Teechain a scenario in which several mutually distrusting parties use blockchain technology to exchange funds and make payments between each other. The parties, or peers, are connected via network communication links where not all peers can communicate with each other directly, e.g., some may reside behind firewalls or NATs. Many peers in the network may have long-lived financial relationships that require frequent interaction with high-throughput and low latency. For example, some peers may belong to currency exchanges or service providers who have a high degree of connectivity in the network and process many payments per second. Other peers in the network may require more infrequent interaction with a smaller degree of connectivity. For example, they may belong to individual consumers or customers who make only several purchases on a daily basis.

The Teechain protocol provides practical, secure, scalable and efficient bilateral off-chain transactions, thus overcoming the limitations of the underlying blockchain protocol.

The Teechain protocol exploits TEEs to enforce the correct operation of mutually distrusting parties during off-chain fund exchanges. In Teechain, TEEs form a distributed trusted third party. They arbitrate between participants in the Teechain network and are responsible for managing and maintaining the global state distribution of funds.

Technically, Teechain runs inside each party's TEE. Teechain then allows the participants to execute a protocol to construct bidirectional payment channels and to exchange payments in a peer-to-peer manner via those channels. To ensure the correct operation of these payment channels, the participant's TEEs remotely attest each other, thus providing guarantees that the other party is running genuine Teechain code within a genuine TEE.

Teechain further provides a protocol to route payments across multiple payment channels, thereby forming payment chains. This allows for payments between Teechain participants that do not share network communication links or payment channels. Such indirect payments reduce the amount of collateral required by the network, since nodes do not need to maintain collateral for a chain with each of their peers. It also poses a more practical deployment model, as senders and receivers of payments do not need to communicate directly with each other.

The threat model in the Teechain embodiment assumes that multiple parties wish to exchange funds but mutually distrust each other. Each party is potentially malicious, i.e., they may attempt to steal funds, avoid making payments, and arbitrarily deviate from the protocol. In particular, parties may drop, send, record, modify, and replay arbitrary messages in the protocol. Either party may crash and stop responding entirely.

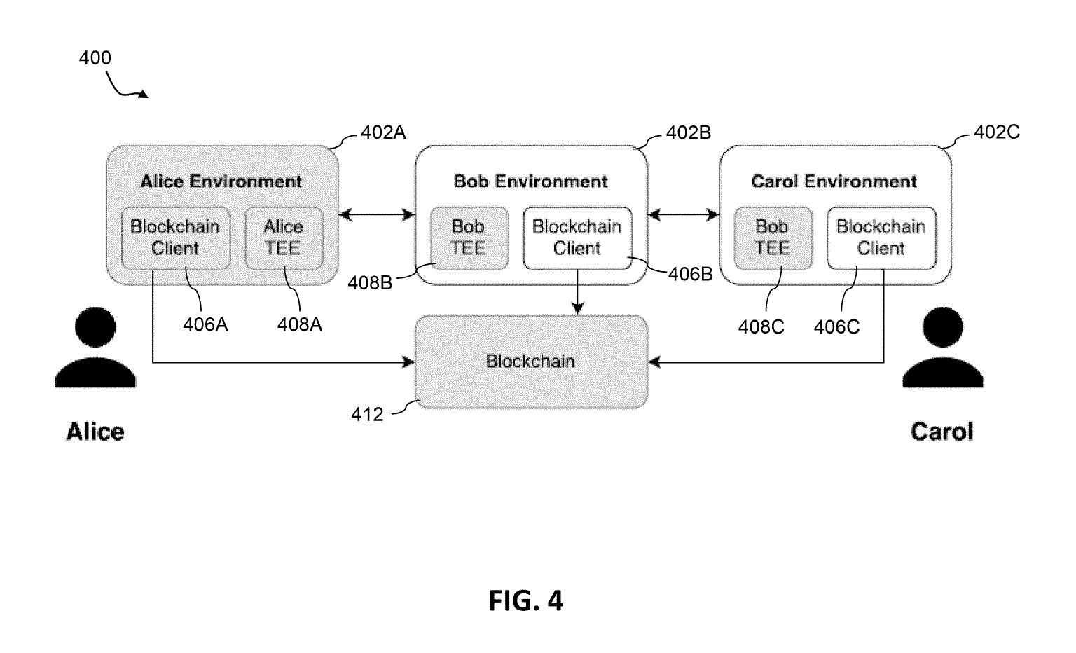

FIG. 4 shows an example of a chain of payment channels implemented between respective pairs of user environments via their respective TEEs in an illustrative embodiment. The chain of payment channels in this embodiment is implemented in an information processing system 400 between respective pairs of user environment processing devices 402A, 402B and 402C associated with respective system users Alice, Bob and Carol. Such an arrangement is illustratively utilized by Alice to route a payment to Carol through Bob, although numerous other payment scenarios are supported.

The processing device 402A of Alice comprises a blockchain client 406A and a TEE 408A. Similarly, the processing device 402B of Bob comprises a blockchain client 406B and a TEE 408B, and the processing device 402C of Carol comprises a blockchain client 406C and a TEE 408C. The blockchain clients 406A, 406B and 406C interact via a blockchain 412. In some implementations of this embodiment, the blockchain clients 406 more particularly comprise respective Bitcoin clients and the blockchain 412 more particularly comprises a Bitcoin network. The TEE 408A interacts with the TEE 408B via an untrusted network. Similarly, the TEE 408B interacts with the TEE 408C via an untrusted network.

Each of the parties in FIG. 4 trusts the cryptocurrency blockchain, its own environment, the local and remote TEEs, and the code that executes the Teechain protocol. The rest of the system 400, including the network channels and the other parties' software stacks (outside the TEE) and hardware are untrusted. More particularly, as illustrated by the shading in the figure, Alice trusts the blockchain 412, her own processing device 402A, and both Bob and Carol's TEEs 408B and 408C.

During protocol execution, any party may access or modify any data in its non-TEE memory or stored on disk, view or modify its non-TEE application code, and control any aspect of its operating system and other privileged software and hardware. We assume the TEE guarantees to hold and do not consider side-channel attacks on the TEE, although as noted above such attacks are difficult to exploit and can be mitigated.

In a Teechain system of the type illustrated in FIG. 4, each participant operates his or her own TEE that executes the secure Teechain protocol.

The Teechain protocol for payment channels in the present embodiment operates as follows:

(1) First, pairs of parties perform remote attestation and open bidirectional payment channels. Before a party may send funds over such a channel, it must provide a deposit in the form of a blockchain transaction output paid into a Bitcoin address owned by a Teechain TEE. For each channel, the TEE of each party acts as a trusted intermediary by holding its party's channel deposits.

(2) While the channel is open, the TEEs securely maintain the channel state. Payments between the two parties may then be performed as long as the provided deposits are sufficient as collateral for the amounts transacted over the channel. The corresponding updates to the TEE internal channel state are performed through a secure interface. Teechain maintains all channel balances and the deposits of all Teechain participants exclusively within TEEs.

(3) A Teechain participant may, at any point in time, issue the termination of any of their payment channels. This can be due to mutual agreement with its counterparty, or a unilateral decision to terminate the channel. The corresponding TEE will then close the channel in a secure manner. Only on termination does a TEE generate a transaction that can be placed onto the blockchain.

In the system 400 of FIG. 4, processing devices 402A, 402B and 402C of Alice, Bob and Carol run their respective TEEs 408A, 408B and 408C alongside respective connections to the blockchain 412, illustratively a Bitcoin network. The connections to the Bitcoin network are only used to create or confirm a deposit, and to terminate a channel.

As indicated previously, Teechain further allows parties to route payments across multiple payment channels. For this, we assume that the party initiating the payment has obtained a path to the receiving party through the network of open Teechain payment channels. To form a payment chain along this path, all involved parties lock the corresponding payment channels, committing not to use them for other payments. They then execute a protocol to reach consensus on the new balance for all of channels. After releasing all locks, the channels are again available for other payments.

If routing of the payment fails, e.g., due to node or network failures, Teechain ensures that all channels of the payment chain are settled consistently either at their pre-payment state or at their post-payment state, depending on the stage that the protocol execution reached at time of failure.

The Teechain protocol will now be described in greater detail. First, we outline the single channel protocol, and then describe how to route payments across several payment channels and how to perform off-chain channel termination. Finally, we describe how Teechain provides fault tolerance.

The Teechain protocol of the present embodiment is configured to establish bidirectional payment channels between pairs of Teechain participants and to exchange funds in a direct manner rather than placing transaction onto the blockchain for every single payment. To safeguard payment channels and payments as well as to prevent fraud by network participants, Teechain makes use of the confidentiality and integrity guarantees provided by TEEs.

To achieve this, each node participating in the protocol runs its own instance of the Teechain TEE, and can generate and release blockchain deposits as collateral for channels. Two nodes can then set up a secure network link and a payment channel. Once the payment channel is set up, each of the parties associates deposits as collateral and they exchange payments. If the parties agree that a deposit is not necessary for their channel, they can release it, making it available for other channels. At any time, either party can unilaterally terminate the channel by cashing out its fair portion of the channel's associated deposits.

TEE Initialization.

A participant Alice that wishes to participate in the Teechain protocol must set up a genuine Teechain TEE and be uniquely identifiable by all other participants to the end of sending and receiving payments. At setup, Alice thus first has her TEE generate a public/private key pair for the purpose of identification within the Teechain network. The public key is revealed to the participants in the network and uniquely identifies Alice's TEE. The private key is securely held inside the TEE, inaccessible to the host Alice or any other parties in the system.

Deposit Creation and Release.

To later perform payments to other Teechain participants, Alice must provide her TEE with deposits. Deposits will be securely held by the TEE and used to secure any of Alice's payments. Alice will only be able to send payments along Teechain channels as long as the sum of all of her payments does not exceed the combined sum of all of her deposits and received payments.

Technically, deposits are transaction outputs that (i) have been paid into a bitcoin address that is held by a Teechain TEE, meaning that the addresses' private keys are only known to the TEE, and that (ii) have been placed onto the blockchain. As a consequence, only the owning TEE is ever able to release those deposits again by generating a corresponding spending transaction. To generate a deposit, Alice instructs her TEE to create a new Bitcoin address by issuing command newAddr. While the TEE maintains and safeguards the generated addresses' private key, the command returns the generated Bitcoin address a to Alice. Alice then (i) creates a transaction t with an output that sends money into the generated address a, (ii) places transaction t on the blockchain, and (iii) issues command newDeposit to provide to the TEE all output details of transaction t, i.e. the transaction ID, the output index and the deposit amount. The TEE verifies the transaction and the fact that it paid into the TEE-generated Bitcoin address and adds it as a free deposit to its deposit registry.

Alice may repeat this step of deposit creation at any time during protocol execution, thus being able to top up the deposits within her TEE. Because Bitcoin transactions can contain multiple outputs, Alice may further use a single Bitcoin transaction to create multiple Teechain deposits, as will be described in more detail below.

At any point in time Alice may issue command releaseDeposit to instruct the TEE to release a free deposit. For this, Alice provides the details of the deposit to be released as well as a designated target Bitcoin address. If the requested deposit is indeed free, the TEE creates and returns a transaction that transfers the corresponding deposit amount to the provided address. Alice can then reclaim the deposit by placing the transaction onto the blockchain. To prevent the user from reusing the same transaction output as a deposit again, the TEE will keep a copy within its deposit registry.

Note that this mechanism is robust against transaction malleability. The user Alice only provides the TEE with a transaction that is placed onto the blockchain. This means that, even if an external party was to maul the transaction and change its ID in the time between Alice constructing the transaction and it being placed on the blockchain, Teechain remains unaffected. This allows mauled Bitcoin transactions to still be used for depositing funds into a Teechain channel or to release funds back to the user.

Secure Link.

For Alice and Bob to interact over a Teechain channel, both need to trust that their counterpart runs the unmodified Teechain code inside a genuine TEE. To this end, each party, Alice and Bob, uses the TEE remote attestation mechanism as follows. Alice and Bob both execute the newNetworkChannel command, which performs a remote attestation handshake between their TEEs. The outcome of this handshake is that (i) each party has verified that its counterpart runs Teechain inside a genuine TEE, and that (ii) the counterpart's public/private key pair was securely generated inside that TEE. The Teechain remote attestation handshake executes an authenticated Diffie-Hellman key exchange to create an AES-GCM-secured network channel. Teechain ensures that any further interaction between the two TEEs: (i) is subject to the correct attestation of both TEEs, and (ii) happens over the secure established network channel.

Teechain performs remote attestation inside each TEE. Specifically, for Intel SGX, remote attestation requires communication with the above-noted third party attestation service IAS. While Teechain performs this communication outside the TEE, it verifies the attestation service's report and the corresponding signature inside the TEE.

Once remote attestation has been successfully completed, Alice and Bob's TEEs share a secure network channel: Alice's TEE can encrypt, sign and authenticate messages with Bob's TEE, and vice versa. Teechain ensures message freshness by using (i) nonces for message requests and acknowledgements, and (ii) strict monotonic counters for payment messages.

Teechain Payment Channel Initialization.

Teechain then uses the established secure communication channel to initialize a secure payment channel between Alice and Bob. For this, Alice and Bob provide their enclaves with the public key of the remote party as well as with their Bitcoin settlement addressees, i.e. addresses that will be paid into upon channel termination. Alice and Bob's TEEs will then agree on a unique channel ID to identify the payment channel. In addition to this channel ID, the two TEEs also exchange the provided public keys and Bitcoin settlement addresses. The TEEs will then (i) associate the provided values with the channel, (ii) create an acknowledgement message confirming the details of the channel, (iii) sign it, (iv) encrypt it for the remote party, and (v) send it to the remote TEE. Upon receiving and verifying such an acknowledgement, the TEEs mark the channel open.

Deposit Association.

Before Alice or Bob may perform payments via the open payment channel, at least one of them must associate deposits with the channel. By associating a TEE-owned deposit with a payment channel, Alice commits this deposit as collateral for this channel. In particular, Alice's TEE will ensure that the same funds will not be used as a collateral for any other channels. However, in order for a deposit to be associated with a payment channel, the remote party must first approve that deposit.

Deposit approval requires the remote party to verify that a deposit has actually been placed onto the blockchain. This prevents a party from presenting their TEE with a valid transaction output without placing it on the blockchain.

If Alice wishes to have a deposit approved by Bob, she issues the command approveMyDeposit, providing the public key of Bob's TEE and the transaction output she wants to have approved. Alice's TEE then sends an approveMyDeposit request to Bob's TEE. Bob verifies that the given transaction output has been placed onto the blockchain and allows his TEE to mark this deposit as approved and return an approvedDeposit message to Alice's TEE. Upon success, Alice's TEE marks the given deposit as approved by Bob.

Once a deposit has been approved by a remote TEE, it is granted the ability to be associated with any payment channel between the pair of TEEs. Note that each deposit must only be approved once for each pair of Teechain participants and that this step must not be repeated whenever the same deposit is reused by the same users. Similar to deposit creation and removal, deposit approval can be performed at any time during protocol execution in order to top up the amount of available deposits.

Alice may then associate any deposit approved by Bob with her payment channel using command associateMyDeposit. For this, she provides the to-be-associated channel ID and deposit. Her TEE asserts that the deposit is free and that it has been approved by Bob. If so, it considers the deposit value as part of the channel collateral, thereby increasing the balance of the channel by the deposit's value. It then locates the corresponding Bitcoin private key that can spend the transaction output, encrypts it for the payment channel, and forwards this as part of the signed deposit association message. By doing this, it allows Bob's TEE to spend this transaction upon channel termination.

Upon receiving Alice's deposit association commitment message, Bob's TEE (i) asserts that the deposit has been approved by Bob, (ii) associates it with the payment channel with Alice, and (iii) acknowledges the deposit association to Alice's TEE. In case Bob's TEE declines the deposit, Alice dissociates the deposit from the channel.

Teechain allows Alice to associate multiple deposits with each channel, thus aggregating collateral. Alice can use this feature to minimize the unused collateral associated with individual channels by (i) providing her enclave with many small deposits rather, and (ii) associating channels with many deposits that are just large enough to cover her payments. Since a Bitcoin transaction may have multiple outputs, this approach does not increase the amount of transactions placed onto the blockchain.

Payment.

Now that deposits have been associated with payment channels, Alice and Bob may perform payments.

When making a payment to Bob, Alice commits not to settle the channel at a state prior to the payment. She achieves this by issuing a pay command, providing a channel ID and the amount to be transferred. If her balance is sufficient to perform the payment, her TEE (i) decreases Alice's channel balance, (ii) confirms the payment, and (iii) and sends a commitment confirmation message to Bob's TEE. Upon receiving this commitment message Bob's TEE increases Bob's channel balance by the provided value.

To avoid replay attacks, Teechain appends a strict monotonically increasing counter to each payment message. Both TEEs remember the counter value and reject any messages not incrementing the value. This prevents old payment messages from being replayed.

Deposit Dissociation.

At any point in time Alice may dissociate deposits the values of which have not been transferred via the channel. This frees the deposit and makes it usable in other payment channels. Deposit removal removes the collateral from the channel, precluding her from payments that require such collateral.

To dissociate a deposit, Alice issues a dissociateDeposit command, providing a channel ID and the deposit to dissociate. Her TEE then verifies whether dissociation is permissible, i.e. whether the value of the dissociated deposit does not exceed her current channel balance. If this is the case, the TEE sends a corresponding dissociatedDeposit to Bob's TEE. Bob's TEE then also verifies whether the dissociation is permissible, and, upon success, dissociates the specified deposit. It also discards the Bitcoin private key that was used to spend the deposit, as it is no longer needed to settle the channel. Upon success, Bob's TEE replies to Alice's TEE with a dissociated DepositAck confirmation message. Alice's TEE will then free the deposit, thereby reducing Alice's channel balance and making the deposit available for association with other channels.

Similar to deposit association, deposit dissociation may be performed at any point in time while the payment channel is open.

Payment Channel Settlement.

Either party may settle the channel according to its current state at any point in time. Depending on the parties' balances in the payment channel, the TEE will generate and return a settlement transaction that redistributes the current balances into the addresses given at channel setup.

To settle the channel, Alice issues a settle command, providing the ID of the channel to be settled. If the balances of the parties in the channel are equivalent to their deposits, that is, equivalent to no payments having been made, the channel can be terminated without needing to touch the blockchain. The deposits can simply be disassociated from the channel. Any payment channel in this state is termed a neutral payment channel because neither party has a surplus or deficit of funds according to their deposits. Otherwise, a settlement transaction is generated that sends the balances of the parties to their settlement addresses using all the deposits currently associated with the channel, and the corresponding private keys to spend from those deposits.

While there is no guarantee that a terminating message will be received by the other endpoint in a channel, this does not affect safety of the channels, only liveness. Eventually the endpoint that still believes the channel to be alive will either have their connection timeout, or will not receive acknowledgements for requests they send, and so will assume the other party to be offline, thus terminating the channel on-chain.

Similarly, there is no guarantee that the two endpoints will generate equivalent settlement transactions. It is possible for both endpoints to see different final states as one may terminate before the other. However, the differences in states is always acceptable to both parties. If one party terminates early, they cannot receive any incoming payments, and thus cannot attain more funds than approved by the opposite party.

We now describe a protocol to route payments across multiple Teechain payment channels, allowing for the formation of Teechain payment chains. Such an arrangement allows parties to exchange payments even if they do not share network links, e.g. such as a merchant and a customer of an online marketplace. A payment chain thus comprises at least two payment channels, and illustratively includes an entire path across which a payment is being routed (e.g. A→B→C→D). It is assumed that a given party is able to determine the path before initiating his or her payment.

For a node to trust the execution of the Teechain payment routing protocol, it must be sure that all nodes of the payment chain have been securely attested. Since Teechain remotely attests adjacent nodes inside the TEE, this trust relation is transitive: if Alice's TEE attested that Bob is running genuine Teechain code inside a genuine TEE, then Alice can trust Bob to attest any other Teechain node prior to forming a payment channel. By transitivity, Alice can thus trust all nodes within the Teechain network.

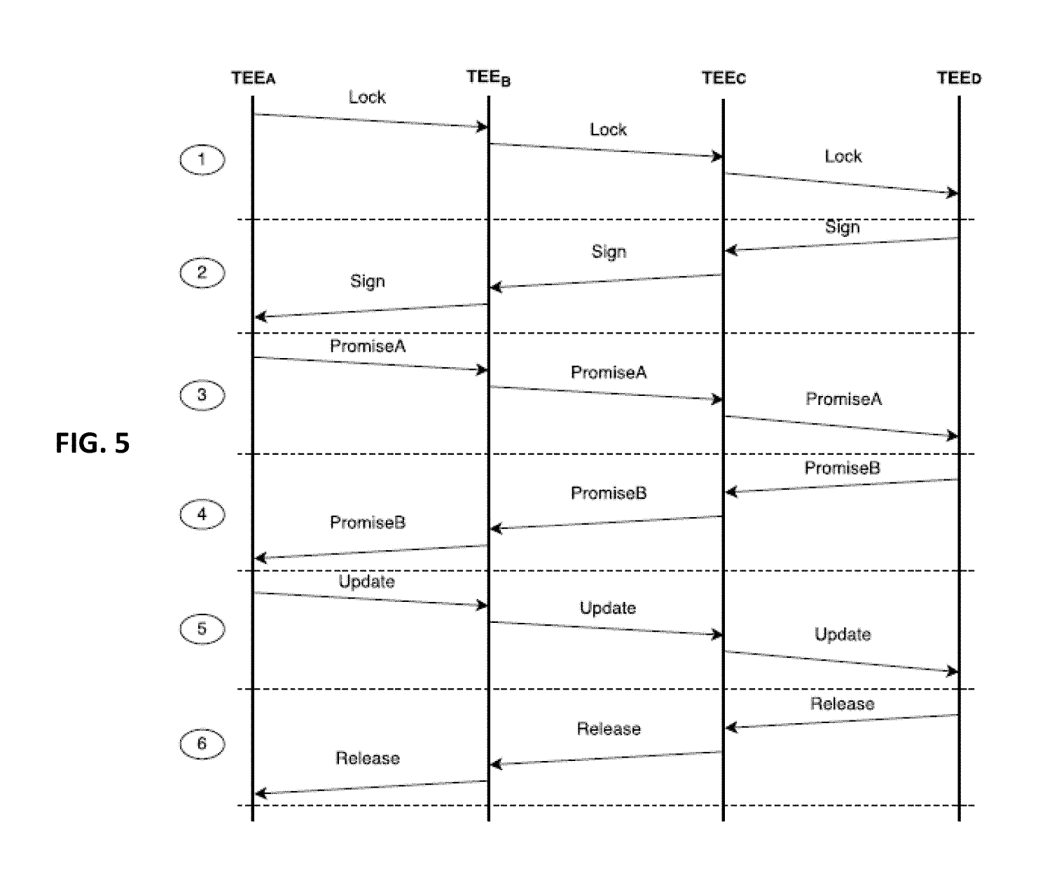

FIG. 5 shows the Teechain protocol of this embodiment in more detail. More particularly, this figure illustrates signal flow between four user environment processing devices associated with respective users Alice, Bob, Carol and Dave, having respective TEEs denoted TEE_{A}, TEE_{B}, TEE_{C} and TEE_{D}. The signal flow in this embodiment includes multiple distinct phases of the Teechain protocol for implementing a chain of payment channels.

For Alice to route a payment to Dave via Bob and Carol, she issues command routePayment, providing (i) the amount of money to be sent and (ii) the public keys of all nodes along the path. Payment routing across this path then proceeds in six stages as shown in FIG. 5 and detailed in the following description. During the protocol, each node passes through all of the six stages. At any time during payment routing, any party may settle on of the channels and eject from the protocol. The resulting settlement transaction will depend on the phase of the protocol that the settling TEE is in.

(1) Lock: Obtaining locks.

The goal of the first stage is to lock the states of all payment channels in the payment chain. For this, the payment initiator's TEE starts by sending a lock message along the set of nodes involved in the payment chain. For each node, Teechain ensures that (i) the payment channel has sufficient funds to route the payment and that (ii) the payment channel is currently idle, i.e. that no other payments are currently being made along that channel. If this is the case for all involved channels, Teechain locks the corresponding channel for payment routing.

Starting from the second node in the chain, the nodes further compose the chain settlement transaction chainSettleTx, a single Bitcoin transaction that settles the state of all channels in the payment chain according to the post-payment state. That is, the state of the channels after the payment has been successfully routed along the chain. To compose this settlement transaction, each node adds the input and output transactions that are required to settle the channel associated with that node. Upon reaching the last node of the chain, the settlement transaction has been composed and all nodes are locked to perform the payment routing.

(2) Sign: Signing the Settlement Transaction.

The last node then starts the second phase, the goal of which is to have the settlement transaction chainSettleTx signed by all nodes. The last node starts by signing chainSettleTx and sending a corresponding sign message along the chain towards the payment initiator. Eventually the initiator will receive and sign the settlement transaction chainSettleTx, thus (i) obtaining the settlement transaction signedChainSettleTx that was signed by all nodes within the payment chain and (ii) starting the third phase of the protocol.

(3) PromiseA: Promise to not Settle Pre-Payment.

The third phase obtains a promise from all nodes to not settle their channel's pre-payment state, i.e. the state of the channel before the payment to be routed has been settled. The purpose of this phase is to distribute the signed transaction signedChainSettleTx to all nodes in the chain, allowing them to ensure that, should they eject from the protocol after this point, they can do so without violating consistency with the rest of the nodes. Specifically, each node promises to (i) only eject from the protocol by placing the signed settlement transaction signedChainSettleTx onto the blockchain, and to (ii) only settle its individual channel in the pre-payment state if another node has placed a transaction settling its local channel in the pre-payment state. We call this phase promiseA. As with the earlier phases, the promise transitively propagates through the payment chain: starting from the initiator, each node makes the above promise to its successor node. The involved nodes' TEEs will enforce the promise upon ejection of a node. Once the last node has committed to this promise, it starts the fourth phase.

(4) PromiseB: Promise to Correctly Settle Post-Payment.

Once all nodes promised to not settle their pre-payment channel state, they update their internal channel balances to reflect the post-payment state, i.e. the channels' states after the payment to be routed has been performed. Further, all nodes promise to (i) only eject from the protocol by placing settlement transaction signedChainSettleTx onto the blockchain, and to (ii) only settle their individual channels in the post-payment state if another node has placed a transaction settling its local channel in the post-payment state. We call this stage promiseB. Yet again, this promise is propagated through all nodes of the payment chain.

Once this phase is completed, the initiator node knows that all nodes in the chain have updated their channel state to the post-payment state and can only eject from the protocol by placing settlement transaction signedChainSettleTx onto the blockchain.

(5) Update: State Update.

Starting from the initiator node, each node then deletes their copy of signedChainSettleTx and undoes the promiseB commitment. This allows each node to settle their own channel in the post-payment state. Once this phase is complete, the last node knows that all nodes in the chain have updated their channels to the post-payment channel state and deleted signedChainSettleTx.

(6) Release: Lock Release.

Going backward along the chain, each node that is notified by its successor releases the channel lock with that node for other uses, such as routing additional payments, and switches back to the idle state. This completes the payment routing.

An implementation involving locking of payment channels along the payment chain is utilized in the present embodiment in order to prevent interference with other payments. Note, however, that any pair of Teechain participants may open multiple payment channels along a single network channel. Therefore, while payment routing is in progress, Alice and Bob may thus open additional payment channels as detailed above to avoid contention, and either exchange payments directly or route other payments in parallel. Additional description below will analyze how the Teechain payment routing protocol always achieves agreement across all nodes of the payment chain.

Off-chain channel termination will now be described in more detail. Payment channels can be terminated either on-chain, by placing a settlement transaction on the blockchain, or off-chain, i.e. without placing any transaction on the blockchain. In Teechain, terminating channels off-chain comes with the benefit that the funds become available immediately and can be used for future payments. In addition, off-chain termination reduces the amount of transactions that must be placed onto the blockchain as well as the amount of collateral that needs to be held in the Teechain network.

Teechain is able to terminate channels off-chain if two nodes of the Teechain network share at least two payment paths, i.e. either payment channels or payment chains. In such a case, Teechain achieves off-chain channel termination by (i) merging the states of multiple payment paths into one single payment path and (ii) dissociating all possible deposits wherever possible. We hereby exploit two features of the Teechain network: (i) the ability to create “payment cycles” comprising more than one payment path between two nodes; and (ii) the ability to close neutral payment channels off-chain by simply disassociating all deposits.

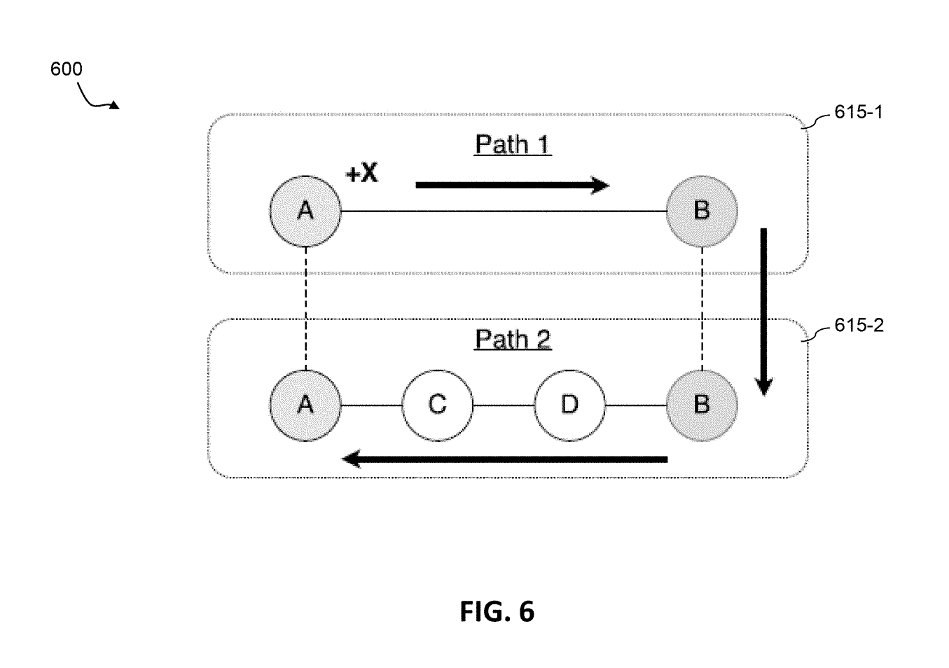

FIG. 6 illustrates the settling of a balance off-chain by moving the difference from one payment channel path to another. An information processing system 600 in this embodiment comprises two payment paths 615-1 and 615-2 between Alice and Bob: path 1 (p₁) is a direct payment channel between Alice and Bob (A→B), while path 2 (p₂) is a payment chain between Alice and Bob via Carol and Dave (B→D→C→A). Together p₁ and p₂ form a cycle in the Teechain network.

If Alice wishes to close p₁ off-chain, she can do so by moving any fund deficit, or surplus, from p₁ to p₂, assuming that there are sufficient funds in the payment path p₂ to allow the surplus/deficit to be routed. This shifting of funds turns payment path p₁ into a neutral payment channel, that can then be terminated off-chain as described previously. For example, if Alice has a surplus of X bitcoins in p₁, i.e. Bob sent her X bitcoins and she made no payments back, she can set p₁ to a neutral state by sending X bitcoins to herself through the cycle of p₁ followed by p₂ (i.e. A→B→D→C→A). She can then terminate the payment channel A→B off-chain.

With regard to fault tolerance, Teechain provides strong security guarantees by having TEEs manage and maintain all funds held in the network. Despite the advantages this provides, this makes Teechain sensitive to TEE crash failures: in case of a TEE crash, any funds held are permanently lost because only the TEE contains the private keys to spend those funds. To avoid such permanent loss of funds, Teechain illustratively utilizes at least one of two fault tolerance strategies depending on the deployment scenario, namely, persistent storage and TEE state replication backup chains.

If Teechain is deployed in an end user environment, where payments happen infrequently, i.e. in the order of magnitude of a dozen payments per minute, Teechain achieves fault tolerance against TEE failures by persisting the TEE-internal state to disk as detailed below. In case of a TEE failure, the persisted state can then be restored and appropriate funds made re-accessible.

If Teechain is deployed in an environment with the goal of achieving high-frequency and low-latency transactions, persisting to disk is not an option due to the current limitations of available TEE hardware monotonic counters. It is therefore reasonable to deploy multiple TEEs in independent failure domains, i.e. data centers. Teechain then achieves fault tolerance by replicating the TEE-internal state to multiple TEE replica in different failure domains as detailed below. The locked funds can then be reliably retrieved as long as at least one replica survives.

Persistent Storage.

When persisting the TEE's state to disk, Teechain takes special care to avoid rollback attacks: upon TEE failure and subsequent state recovery, an attacker might present the TEE with a stale state with the goal to, e.g., revoke previous payments. Teechain thus uses (i) hardware monotonic counters and (ii) secure data sealing whenever persisting the TEE's state: encryption and digital signatures ensure the confidentiality and integrity of the persisted data, while hardware monotonic counters prevent rollback attacks. The end user may further use RAID technology or auto-backup solutions such as Dropbox to resist disk failures.

Concretely, Teechain persists the TEE's state as follows. Whenever a payment is to be sent or whenever a payment is received, Teechain first increments the hardware monotonic counter and waits for the TEE's state to be securely written to disk. Only after receiving a corresponding acknowledgement will Teechain send the payment to the remote TEE or reflect the incoming payment within the local TEE. This prevents users from rolling back any payments by crashing their TEE. With current monotonic counter implementations, which throttle monotonic counter increments to approximately 10 per second, this fault tolerance strategy is able to scale up to 10 tx/sec, a value that is likely sufficient for end users and most small businesses.

TEE State Replication: Backup Chains.

The above fault tolerance strategy does not scale in the presence of high-frequency and low-latency transactions. Teechain thus also provides a fault tolerance strategy that avoids hardware monotonic counters and instead replicates the primary TEE's state to remote TEEs, i.e. backup Teechain instances that are ideally located in different failure domains. The role of a backup is to replicate the state of the primary, thereby providing an ability to settle any channels or release deposits, should the primary fail.

Teechain organizes backup nodes in the form of chains: for each Teechain TEE, either primary or backup, the user is able to dynamically add or remove a single backup TEE at runtime. Upon adding a backup, Teechain will perform a remote attestation procedure as described previously. It then achieves fault tolerance as follows. Whenever a primary TEE sends an outgoing payment or receives an incoming payment, it first contacts its backup TEE to replicate the new state. This backup may, in turn, first contact its own backup for the same matter. This continues all the way to a TEE that doesn't have a backup. After receiving a state update acknowledgement from its backup, the primary knows that all backups have been updated and can then proceed to either send the payment or process an incoming one.

In addition, Teechain also provides the ability to perform asynchronous state replication to backup nodes on incoming payments. In the case that a Teechain node receives many incoming payments, the rate at which Teechain state is replicated to backup nodes can be configured by each user, allowing them to maintain a bounded amount of money that is not replicated. This trades off fault-tolerance for the benefit of improved latencies when processing incoming payments. Note however, that this doesn't affect the safety of the protocol; any attempted rollback attack here could only lose money.

We now describe how Teechain mitigates potential attacks and then analyze the chain and channel protocols.

With regard to attack mitigation, Teechain is configured to secure assets and resources within the Teechain network. While we exploit the security guarantees of TEEs, attackers may still drop, send, record, modify, and replay arbitrary messages at any time during protocol execution. They may further try to misuse any information available to them outside of the TEE, e.g. persistently stored backups of the TEE-internal state. Note that any external adversary, such as an attacker who has compromised the network, has fewer privileges than any legitimate Teechain participant and can thus be subsumed by a malicious Teechain participant.

Remote Attestation and Transitive Trust.

As described above, Teechain attests remote TEEs before setting up any payment channels. By performing remote attestation inside the TEE, Teechain ensures that all TEEs of the Teechain network run genuine Teechain code within genuine TEEs. With this, Teechain achieves transitive trust relationships and precludes bad backup chains or colluding parties across payment chains.

Data and Message Confidentiality and Integrity.

Teechain protects the confidentiality and integrity of any sensitive data by only ever maintaining it in the clear inside the TEEs. This data includes Bitcoin addresses, their associated public and private keys, payments between Teechain participants, channel balances, as well as any other parts of the TEE-internal state. When any sensitive data, such as payment information, must be communicated between TEEs, it is only ever communicated over the secure communication channels established during remote attestation. Teechain further uses cryptographic signatures to verify the integrity of messages.

Payment Message Freshness.

Teechain protects all point-to-point payments in a channel against replay attacks by enriching each message with a fresh value obtained from a TEE-internal strictly monotonic counter. To protect payments across chains, the payment initiator securely generates a nonce for each protocol round-trip. This nonce is then used by all TEEs along the payment chain and verified upon receiving responses. Teechain protects any other messages between two TEEs in the same manner, i.e. by including nonces whenever messages require acknowledgements.

Security of Deposits and Payments.

Teechain safeguards from TEE crashes by providing two different fault tolerance strategies. Due to the volatile nature of TEEs, accidental crashes might result in the indefinite loss of funds. By exploiting hardware monotonic counters in persistent storage, and chain replication, users are able to recover crashed states, obtain settlement transactions for open payment channels, and release all unused deposits.

Freshness of Persistent TEE State Backups.

Teechain prevents attackers from replaying stale backups that have been created as part of Teechain's fault tolerance strategy. Whenever a Teechain TEE stores the TEE-internal state to stable storage, it protects the content using encryption, a cryptographic signature, as well as a monotonic counter being maintained by the TEE hardware. Upon restoring a backed up state, the TEE verifies that the backup's counter value corresponds to the current value of its monotonic hardware counter, thus ensuring that only the most recent state is being loaded.

Honesty of TEE Backup Replica.

Attackers may try to misuse state replicas, i.e. backup TEEs, to obtain, e.g., settlement transactions while spending the same funds on a payment channel from within the primary TEE. Teechain prevents such attacks by requiring the backup TEEs' acknowledgements before triggering any TEE-internal state change. As a consequence, and also because backup TEEs are remotely attested, any such attacks will result in state violations either within the primary or within the backup TEE-thus being unable to spend the same funds more than once.

Reliance on Host System.

Even though TEEs provide security guarantees, the correct functional operation of Teechain relies on services provided by the untrusted hardware, operating system, and network. For example, at any point in time the operating system might provide incorrect results through system calls, decide not to further execute the Teechain TEE, or not to deliver network messages in either direction. While the security of Teechain is not affected by any such malicious behavior, single Teechain instances might be subject to denial of service attacks. The fault tolerance provided by Teechain ensures that no funds can be stolen in the presence of such attacks. In case the Teechain TEE is provided with meaningless system call results or network messages, the most secure mitigation strategy is to immediately terminate any open payment channels.

The security of the illustrative Teechain channel and chain protocols will now be described in more detail.

With regard to the security of the channel protocol, it can be shown that, at any point of the execution, a participant Alice with a channel with Bob can claim at least her channel balance with asynchronous access to the underlying blockchain.

The balance on the channel is backed by deposit transactions placed by the parties. For every deposit associated with the channel at a given time, Alice either created it or has approved it, given the commitment from Bob. Moreover, Alice did not approve the dissociation of the deposit. Therefore, Bob's enclave has not issued a transaction that spends the deposit before association, and has not done so since, as the deposit is still associated to the channel.

For every payment made to Bob, Alice deducts the amount from the channel balance, and for every payment received from Bob, Alice increments the balance by that amount. At that time, Alice can generate a transaction that terminates the channel, send it to the blockchain and have it eventually (due to asynchrony) placed in the blockchain, unless Bob has already placed a transaction that spends the deposits. It remains to show that, in this latter case, Alice receives at least the amount she expects according to her record of the balance. And indeed, for every payment made from Bob, Alice is guaranteed that his enclave updated its record of the balance with that amount. Bob might not have delivered all of Alice's payments to his enclave, but that only distorts his balance record in Alice's favor.

With regard to the security of the chain payment protocol, it can be shown that it settles all channels of the payment chain consistently. More precisely, for every finite execution of the Teechain payment routing protocol described above, every node p either (i) agrees with both its neighbors on the new state, or (ii) settles on the network such that both its channels with both its neighbors are consistently settled in either pre-payment or post-payment state of the entire chain. This is illustrated below for the possible stages of idle, locked, signed, promiseA, promiseB and update.

Stage: Idle.

At any given point in time, if p is in stage idle then all other nodes of the chain are either in stage idle or locked. In both cases, p and all other nodes can only obtain the pre-payment local settlement transactions from their enclave, which will subsequently stop the protocol and not produce any other payments or transactions.

Stage: Locked.

If p is in stage locked, all other nodes are either (i) some in stage idle and some in stage locked, or (ii) some in stage locked and some in stage signed. In both cases, all nodes can only settle their local chains at the pre-payment state. If only one node does so, p can settle the other side by calling eject. The node can also do so voluntarily if it suspects that the other nodes prevent progress.

Stage: Signed.

If p is in stage signed, all other nodes are either some in stage locked and some in stage signed, or (ii) some in stage signed and some in stage promiseA.

Case (i). If a node in the locked stage ejects, it settles its local channels in the pre-payment state. It will subsequently block the behavior of the protocol and no node will reach the promiseA stage. Nodep can then eject as well (observing the settlement of one of its channels or voluntarily), resulting in a pre-payment settlement of its local channels. If a node at the signed stage ejects, it also settles a local channel at the pre-payment state, and the conclusion is as before for p.

Case (ii). A node in the promiseA stage might choose to eject with the global post-payment settlement transaction. In this case, both of p's channels will also be settled in the post-payment state.

Stage: promiseA.

If p is in stage promiseA, all other nodes are either (i) some in stage signed and some in stage promiseA, or some in stage promiseA and some in stage promiseB.

Case (i). Any of the nodes in stage signed can choose to eject by settling any of the chain channels in the pre-payment state. In this case, node p can call eject, present its enclave with the single-channel settling transaction, obtain settlement transactions for both its channels, and settle them at the pre-payment state. Node p can also voluntarily eject and obtain the chain settlement transaction. Placing this transaction in the blockchain will only fail if one of the channels was already settled, in which case node p can present its enclave with the channel settlement transaction and obtain settlement transactions for its channels as above.

Case (ii). Any nodes in the promiseA stage and promiseB stage can eject and settle the chain at post-payment state. If nodes have reached promiseB, then all nodes passed stage signed, therefore none can generate local settlements.

Stage: promiseB.

If p is in stage promiseB, all other nodes are either (i) some in stage promiseA and some in stage promiseB, or (ii) some in stage promiseB and some in stage update.

Case (i). Any nodes in the promiseA stage and promiseB stage can eject and settle the chain at post-payment state. None can generate local settlements.

Case (ii). Nodes in update have updated their channels and can only settle their local channels at post-payment state. Node p can present its enclave with the single-channel settling transaction, obtain settlement transactions for both its channels, and terminate its channels.

Stage: Update.

If p is in stage update, all other nodes are either some in stage promiseB and some in stage update, or (ii) some in stage update and some in stage idle.

Case (i). Nodes in the promiseB stage can only voluntarily settle the entire chain. Nodes in stage update can settle their local channels at post-payment, and node p can do the same.

Case (ii). Nodes in the update and idle states can only settle their local channels at post-payment, and node p can do the same.

Stage: Idle.

Finally, when node p returns to the idle stage, all other nodes are either all idle, or some are in stage promiseB. In both cases, the nodes can only settle their local channels at the post-payment state.

As noted above, illustrative embodiments of the Teechain protocol makes use of channel lock. Locks do not prevent a party from settling their channels but rather from performing parallel payments on the same channel. This locking is implemented in some embodiments because a failure during the routing protocol requires all deposits to be spent upon channel termination. Attempting to lock only the in-flight payment by spending only part of the deposit and returning the rest to the TEE cannot be performed automatically due to the transaction malleability problem; it would require both parties in the payment channel to check the blockchain and provide their TEEs with the transaction IDs of the transactions that returned change to the TEEs.

To avoid this, Teechain takes an alternate approach: during payment routing it allows TEEs to create an arbitrary number of payment channels between any two Teechain nodes, as long as unused outputs to open additional channels are available. As a consequence, Teechain supports parallel payments between two nodes. In combination with the possibility to use multiple outputs of a single setup transaction on different channels, Teechain can dynamically create additional payment channels without the need for user intervention.

For example, assume Alice and Bob share an open payment channel, and that they have already approved a set of deposits for one another. Using any free and approved deposits, the two TEEs can create as many payment channels between the two TEEs as required in order to maintain an open and unlocked payment channel between the two parties at all times. This approach prevents bottlenecks at commonly used payment paths and can support the demand of routing payments across Alice and Bob concurrently. Once multiple payments have been successfully routed, Teechain can “merge” all channels sharing the same endpoints and unlock any unused deposits.

This approach motivates an exponential distribution in the size of transaction outputs that are to be used as channel deposits (i.e. 2^{x}, x∈ [symbol] ). The idea then is to use for each payment to be routed, the smallest unused output satisfying the request, thus locking as little funds as possible.

Teechain is able to reduce the collateral on payment channels by dynamically moving funds between channels as well as to and from the deposit registry. This allows Teechain to operate with as little funds as possible. This approach is also facilitated by the use of single blockchain transactions with multiple outputs, whereby each output can be used as a separate fund. Note, however, that there is a trade-off between transaction output granularity and the space required on the blockchain: the smaller the transaction outputs, the more flexibility there is for associating funds with channels and reducing collateral; but, more outputs require more space on the blockchain.

Performance evaluation of a prototype implementation of Teechain will now be described in more detail.

As indicated previously, we implemented the Teechain prototype and evaluated its performance in a realistic environment with nodes in the US and in Europe. The implementation utilized the Intel SGX SDK v1.7 for Linux and ported a subset of Bitcoin Core to an Intel SGX enclave. As in the Teechan prototype previously described, only several features of Bitcoin core are utilized in this Teechain prototype: (i) Bitcoin address generation; (ii) transaction creation; (iii) transaction signing; and (iv) signature verification. Teechain in this particular prototype is implemented using 77,000 lines of trusted C/C++ code inside the enclave, and 5,000 lines of untrusted code. We deactivate hyper-threading and compile the applications using GCC 5.4.0 with −O2 optimizations for all experiments.

For fault tolerance, Teechain as implemented in the prototype uses both chain replication and persistent storage as described previously. Since the Intel SGX SDK for Linux does not provide hardware monotonic counter support, we emulate it by waiting 100 ms, the latency reported in microbenchmarks of the Windows SDK.

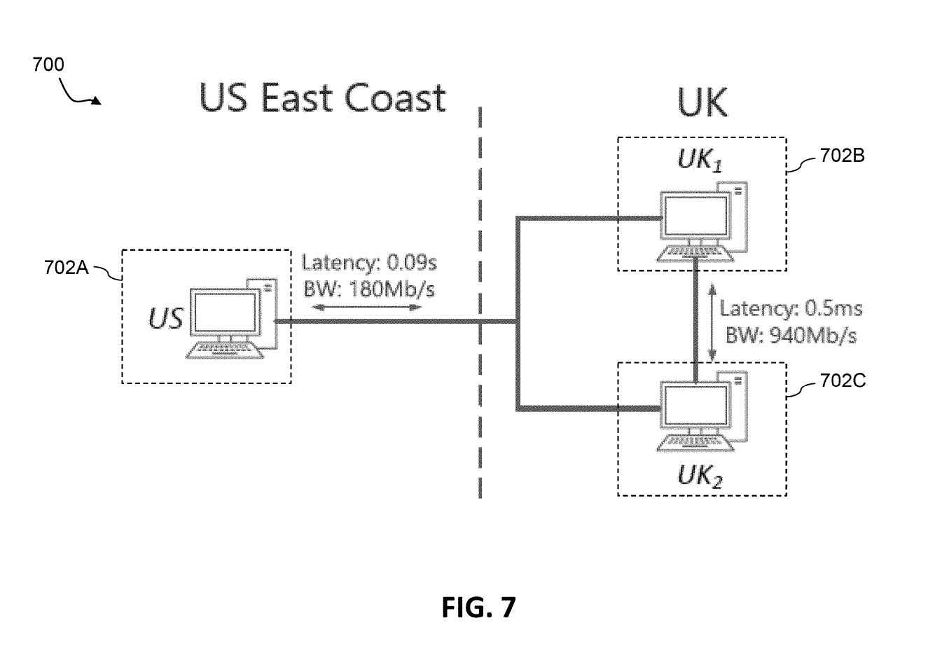

FIG. 7 illustrates the Teechain prototype configuration. The prototype is implemented in an information processing system 700 with multiple geographically-distributed nodes 702A, 702B and 702C configured to implement blockchain payment channels with TEEs using the Teechain protocol.

The nodes 702A, 702B and 702C in this embodiment are more particularly implemented as respective SGX-enabled machines, two in the UK and one on the US East Coast. The two machines in the UK (UK₁ and UK₂) each include an Intel Xeon E3-1280 v5 processor and a 64 GB memory. The machine in the US includes an Intel i7-6700K processor with a 32 GB memory. All machines run Ubuntu 16.04.2 LTS. UK₁ and UK₂ are in the same cluster, and are connected by a network link with an average round trip time (RTT) of about 0.5 ms and a bandwidth of about 1 Gb/sec, or more particularly 940 MB/sec as shown in the figure. Communication between the US and the UK machines is done via SSH-tunneling, across a network with an average measured latency of about 90 ms in RTT and an average bandwidth of about 170 MB/sec from the UK to the US and about 200 MB/sec from the US to the UK. An average bidirectional bandwidth of about 180 MB/sec is shown in the figure.

With regard to blockchain synchronization, we measure the performance of off-chain payment channels, i.e. without access to the blockchain. Measuring blockchain access times is orthogonal to our approach. In addition, blockchain write latencies depend on parameters inherent to the blockchain implementation, e.g. tens of minutes for Bitcoin; read latencies depend on individual implementations, e.g. operating an in-memory store of the blockchain, or contacting an external APL. In Teechain, access to the blockchain is only required to create deposits or settle channels. Sending, receiving and routing of payments, as well as the creation of payment channels and chains do not require blockchain access.

To evaluate the performance of Teechain, we measure throughput and latency of payment channels and payment chains. To understand the performance impact of fault tolerance, we further perform experiments where Teechain nodes use either persistent storage or chain replication.

We define throughput to be the maximum number of transactions sent on a channel or a chain per second. To measure the throughput, we send x payments to the counterparty and measure the time Δₜ from the initiation of the first payment until the receipt of the x-th acknowledgement. We vary the number of payments and the slope of the linear regression of x over Δₜ is the throughput. We define latency to be the time measured from the moment a payment is issued until the acknowledgement for that payment is received.

To test the throughput and latency of Teechain, we construct a payment channel between US and UK₂ and measure the performance. We repeat each experiment 10-20 times. On a channel between UK₁ and US without fault tolerance, Teechain achieves an average throughput of 111,000 tx/sec, and a latency of 86 ms. The measured latency is similar to the raw channel's latency, as only one single message is needed per payment. This represents two orders of magnitude throughput improvement compared to conventional approaches such as Lightning Network.

Adding chain replica for fault tolerance, we evaluate a payment channel from UK₁ to US, while using UK₂ as a backup node for UK₁. We further set up a payment channel between UK₁ and UK₂, using US as a backup for UK₁. In both cases, the average latency is 123 ms due to the additional communication with the backup nodes; we achieve an average throughput of 33,000 tx/sec.

To evaluate the effect of persistent storage for fault tolerance, we activate the functionality on both UK₁ and US and send transactions from UK₁ to US. As expected, performance is capped by the hardware counter's latency of 100 ms per update, resulting in a throughput of about 10 tx/sec and a latency increase of around 100 ms when compared with the results without fault tolerance.

Lastly, we measure the time that it takes to create a secure network link and payment channel between UK₁ and US. Our measurements show that this takes around two seconds as a result of performing a Diffie-Hellman key exchange, contacting the IAS for remote attestation and initializing the payment channel state.

Next, we measure the latency for a three-step payment chain: UK₁→US→UK₂. Results indicate that Teechain takes 2.28 sec to perform the payment. As expected, this results shows a somewhat longer latency than that of Lightning Network, as Teechain requires three round trips between UK₁ and UK₂ in order to complete a payment, while Lightning Network requires only 1.5 round trips.

When all nodes in the chain employ persistent storage for fault tolerance, latency increases as a function of the number of times each node must update its monotonic counters. In this case, UK₁ and UK₂ both increment their monotonic counters three times, once for every two stages of the routing protocol because they are nodes on the edges of the chain. The US increments its monotonic counter six times. This increases the latency by around 0.9 sec, resulting in a total payment latency of 3.5 sec.

We observe similar results when employing backup replica for fault tolerance. The latency becomes a function of the additional RTTs, as each node must wait for its replica to acknowledge the state updates. In this experiment, we use the US to act as backup for the UK₁ and UK₂ and vice versa. We observe the additional latencies across the Atlantic when replicating state. Since the RTT is slightly less than the 100 ms required by the hardware counters, the observed overall latency is slightly smaller.

When routing payments across payment chains, Teechain is predominantly bound by the network latencies between nodes. The total time to route a payment increases linearly with the nodes in the payment chain. The overheads of our implementation are minimal when compared to those of the network. To compare these costs we also routed payments between the two UK machines having minimal network latencies. We assigned both machines two backup replicas each, themselves and the other machine, resulting in six Teechain nodes overall. We routed a payment across two channels, back and forth between the machines. The time to route the payment was 0.22 sec, only 10% of the time taken to route the payment across the Atlantic. In fact, we found that routing a payment across 10 channels back and forth between the two machines took only 0.41 sec. Comparing these to the results across the Atlantic presented above, network latencies far outweigh those of the implementation.

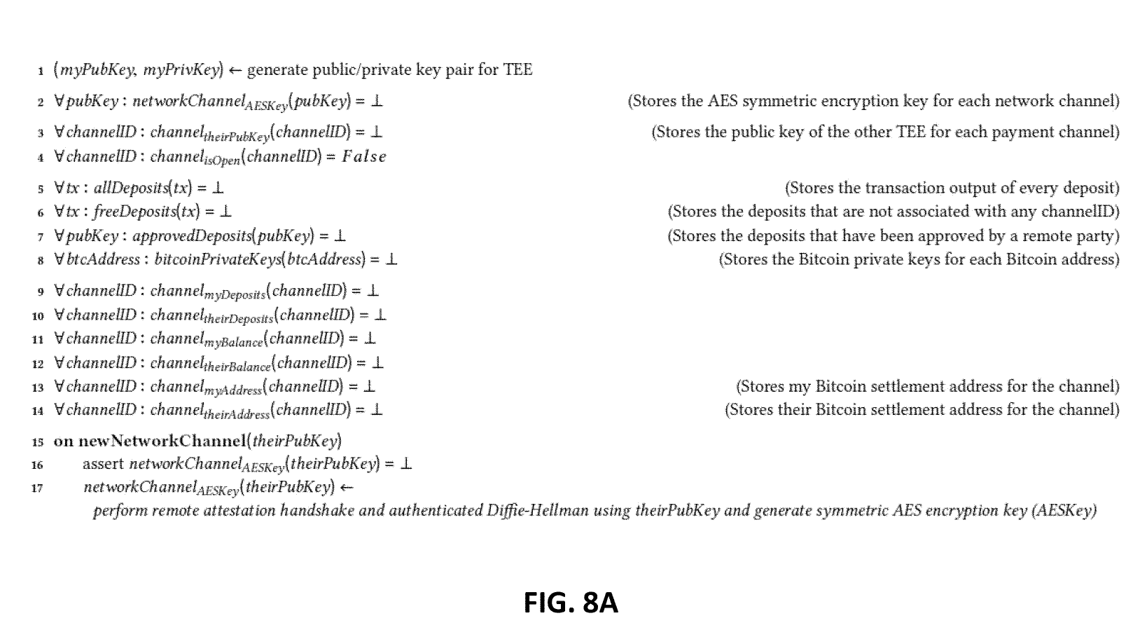

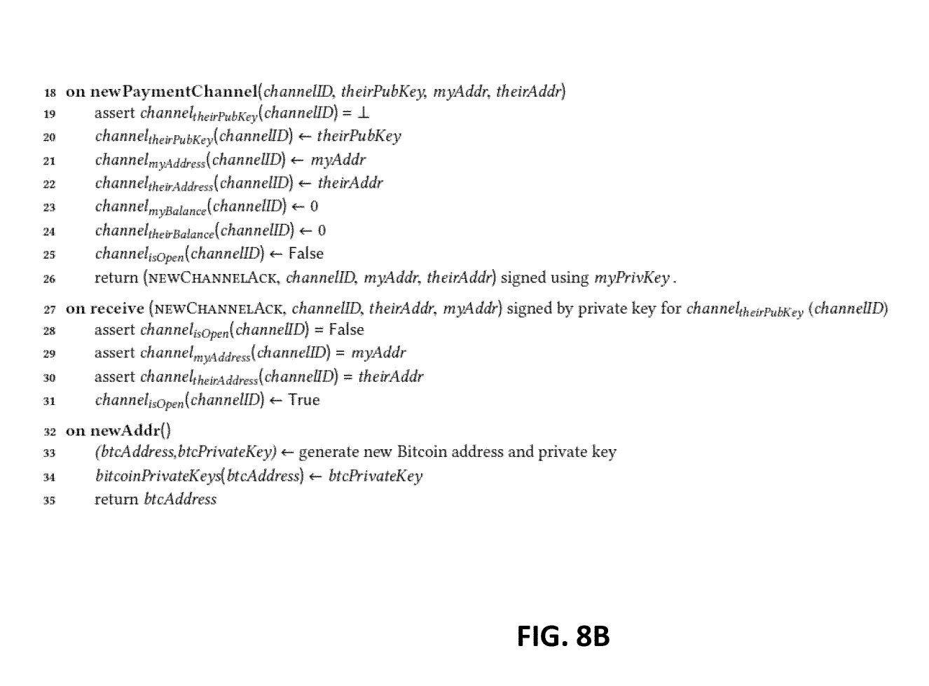

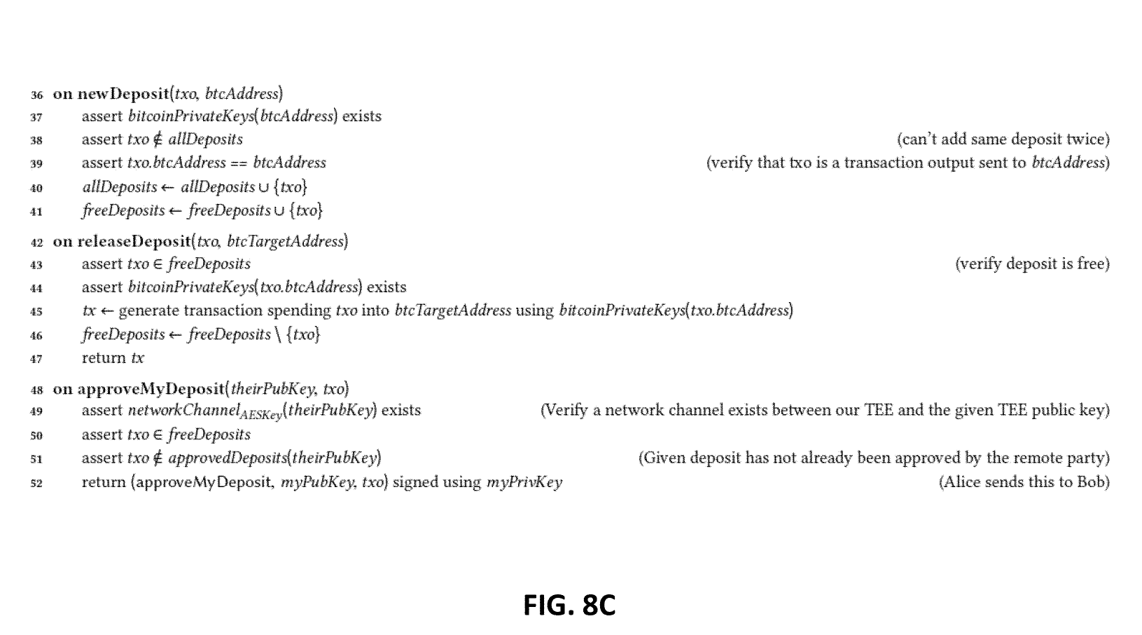

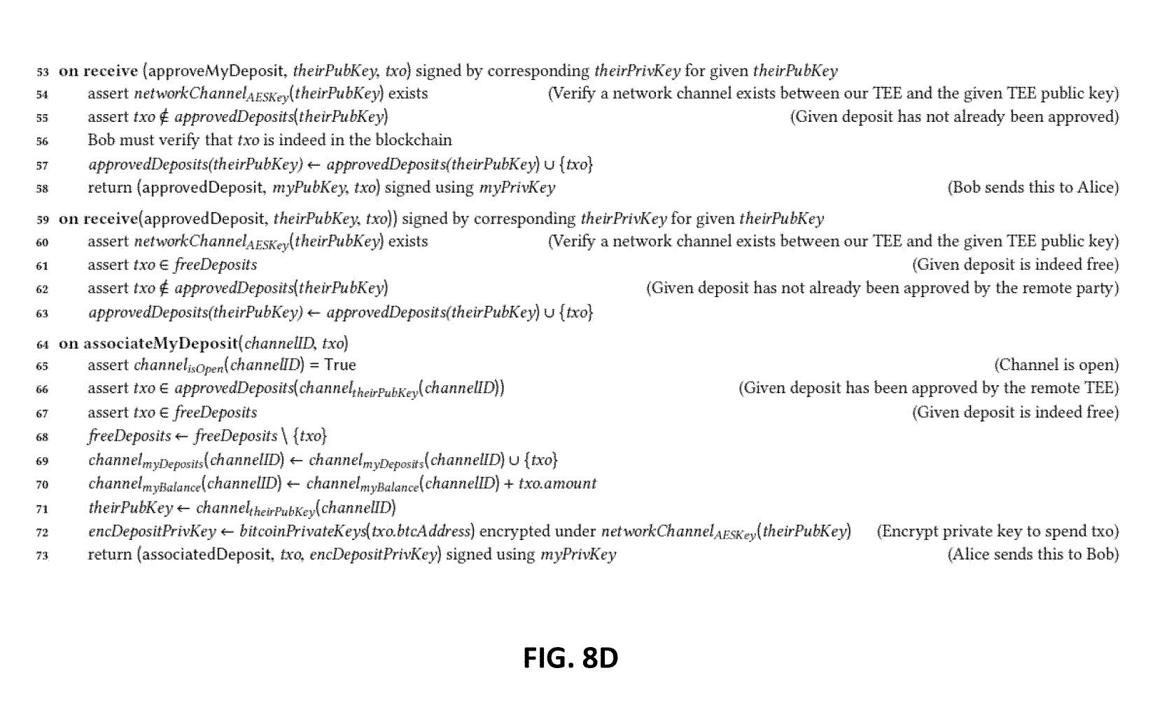

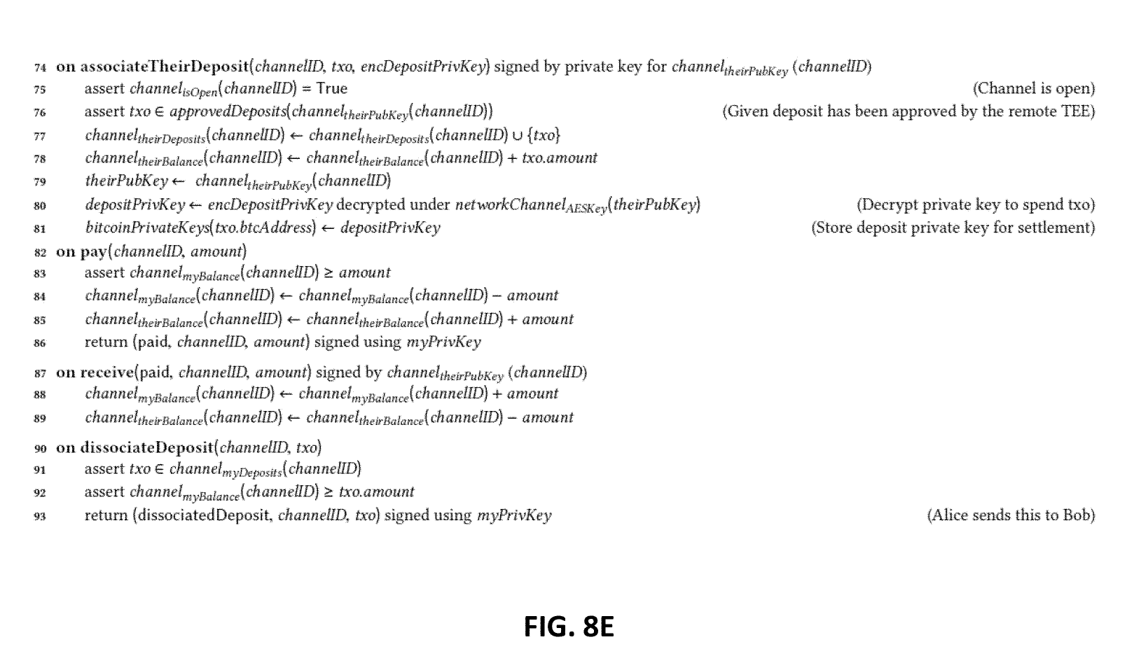

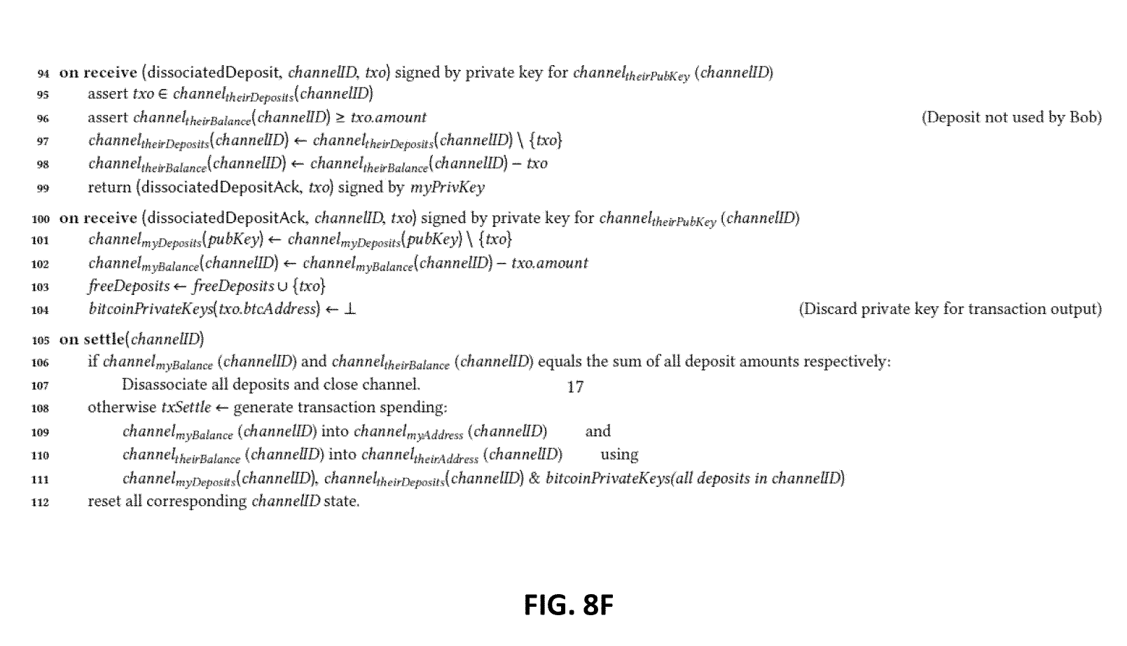

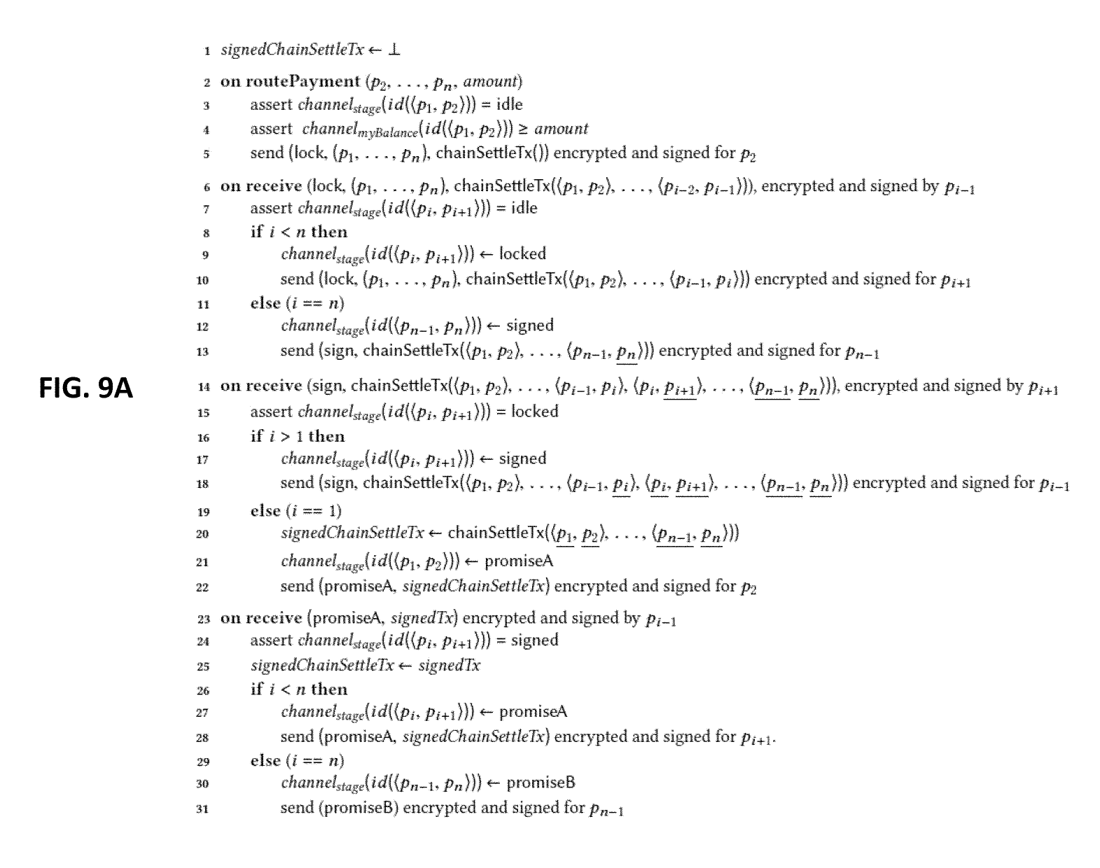

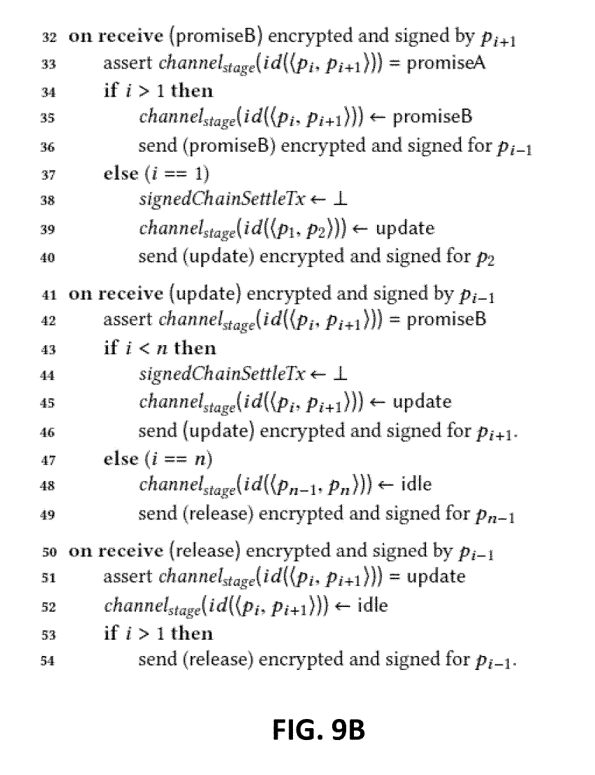

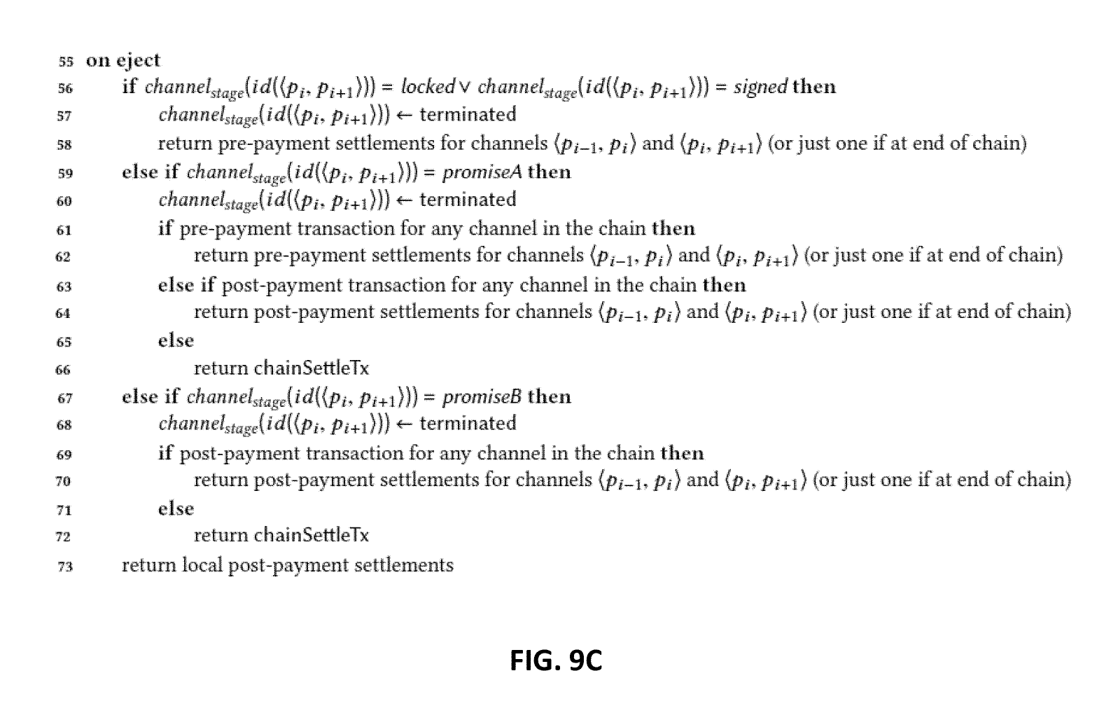

Examples of pseudocode used to implement portions of the Teechain protocol as described above are shown in FIGS. 8 and 9. More particularly, FIGS. 8A through 8F show example pseudocode for single-channel trusted execution, and FIGS. 9A through 9C show example pseudocode for trusted execution at a particular node. These particular pseudocode arrangements are presented by way of illustrative example only, and should not be construed as limiting in any way.

The Teechain embodiment described above provides significant additional advantages relative to conventional approaches.

For example, payment channel lifetimes are unbounded and there is no limit on the total amount moving in any direction. Additionally, Teechain places at most two transactions on the blockchain per payment channel.

In Teechain, a payment is done with a single message, and payments in both directions can be made concurrently. On disagreement, Teechain places only two transactions in the blockchain. Also, Teechain uses the structure of the chain to maintain security guarantees. As in storage chain replication reads, any server or other node in the chain can be accessed to unilaterally terminate the payment channel. However, in Teechain such an operation, by design, irrevocably breaks the replication chain, as the operator now holds the capability to settle the channel at its current balance.

As is apparent from the above description, Teechain provides a TEE-based protocol for payment channels and chains with only asynchronous access to an underlying blockchain. We achieve Teechain's guarantees utilizing a distributed protocol that separates each party's state between its TEE-protected environment and its unprotected environment. Unlike previous solutions, Teechain can be directly deployed to the operational Bitcoin blockchain. Moreover, although our experiments were specific to the Bitcoin blockchain and to Intel SGX, the protocol is adaptable in a straightforward manner to other blockchains and Intel SGX can be replaced with alternate TEE implementations. Teechain provides quantitative improvements over existing solutions with orders of magnitude performance gains compared to conventional approaches such as Lightning Network.

It is to be appreciated that the various embodiments disclosed herein are presented by way of illustrative example only, and should not be construed as limiting in any way. For example, the example Teechan and Teechain protocols and their particular features and implementation details as described above are considered illustrative embodiments only. Numerous alternative arrangements for implementing payment channels for blockchains can be utilized in other embodiments.

Accordingly, the embodiments described above are considered illustrative only, and should not be viewed as limited to any particular arrangement of features. For example, those skilled in the art will recognize that alternative processing operations and associated system entity configurations can be used in other embodiments. It is therefore possible that other embodiments may include additional or alternative system entities, relative to the entities of the illustrative embodiments. Also, the particular messaging formats and other aspects of the illustrative protocols can be varied in other embodiments.

It should also be noted that the above-described information processing system arrangements are exemplary only, and alternative system arrangements can be used in other embodiments.

A given client, server, processor or other component in an information processing system as described herein is illustratively configured utilizing a corresponding processing device comprising a processor coupled to a memory. The processor executes software program code stored in the memory in order to control the performance of processing operations and other functionality. The processing device also comprises a network interface that supports communication over one or more networks.

The processor may comprise, for example, a microprocessor, an ASIC, an FPGA, a CPU, an ALU, a GPU, a DSP, or other similar processing device component, as well as other types and arrangements of processing circuitry, in any combination. For example, a given cryptographic processing module of a processing device as disclosed herein can be implemented using such circuitry.

The memory stores software program code for execution by the processor in implementing portions of the functionality of the processing device. A given such memory that stores such program code for execution by a corresponding processor is an example of what is more generally referred to herein as a processor-readable storage medium having program code embodied therein, and may comprise, for example, electronic memory such as SRAM, DRAM or other types of random access memory, ROM, flash memory, magnetic memory, optical memory, or other types of storage devices in any combination.

Articles of manufacture comprising such processor-readable storage media are considered embodiments of the invention. The term “article of manufacture” as used herein should be understood to exclude transitory, propagating signals.

Other types of computer program products comprising processor-readable storage media can be implemented in other embodiments.

In addition, embodiments of the invention may be implemented in the form of integrated circuits comprising processing circuitry configured to implement processing operations associated with payment channels as well as other related functionality.

Processing devices in a given embodiment can include, for example, laptop, tablet or desktop personal computers, mobile telephones, or other types of computers or communication devices, in any combination. For example, a computer or mobile telephone can be utilized by a user to perform payment channel processing of the type disclosed herein. These and other communications between the various elements of an information processing system comprising processing devices associated with respective system entities may take place over one or more networks.

An information processing system as disclosed herein may be implemented using one or more processing platforms, or portions thereof.

For example, one illustrative embodiment of a processing platform that may be used to implement at least a portion of an information processing system comprises cloud infrastructure including virtual machines implemented using a hypervisor that runs on physical infrastructure. Such virtual machines may comprise respective processing devices that communicate with one another over one or more networks.

The cloud infrastructure in such an embodiment may further comprise one or more sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the information processing system.

Other types of virtualization may additionally or alternatively be used in a given processing platform in illustrative embodiments. For example, Docker containers or other types of containers implemented using respective kernel control groups of an operating system of a given processing device may be used. It is also possible for such containers to run on virtual machines controlled by a hypervisor.

Another illustrative embodiment of a processing platform that may be used to implement at least a portion of an information processing system as disclosed herein comprises a plurality of processing devices which communicate with one another over at least one network. Each processing device of the processing platform is assumed to comprise a processor coupled to a memory.

Again, these particular processing platforms are presented by way of example only, and an information processing system may include additional or alternative processing platforms, as well as numerous distinct processing platforms in any combination, with each such platform comprising one or more computers, servers, storage devices or other processing devices.

For example, other processing platforms used to implement embodiments of the invention can comprise different types of virtualization infrastructure in place of or in addition to virtualization infrastructure comprising virtual machines, such as operating system based virtualization infrastructure comprising containers implemented using respective kernel control groups.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in an information processing system. Such components can communicate with other elements of the information processing system over any type of network or other communication media.

As indicated previously, components of the system as disclosed herein can be implemented at least in part in the form of one or more software programs stored in memory and executed by a processor of a processing device. For example, certain types of functionality associated with payment channel processing of a given processing device can be implemented at least in part in the form of software.

The particular configurations of information processing systems described herein are exemplary only, and a given such system in other embodiments may include other elements in addition to or in place of those specifically shown, including one or more elements of a type commonly found in a conventional implementation of such a system.

For example, in some embodiments, an information processing system may be configured to utilize the disclosed payment channel techniques to provide additional or alternative functionality in other contexts.

Thus, techniques illustrated in some embodiments herein in the context of implementing payment channels for the Bitcoin blockchain can be adapted in a straightforward manner for use in other contexts involving different types of blockchains, such as blockchain processing in the context of Ethereum or other electronic currency systems, as well as in numerous non-blockchain contexts, such as payment channels configured for SWIFT transactions or other types of payment transactions. Accordingly, illustrative embodiments of the invention should not be viewed as limited to any particular types of blockchains and/or electronic currencies or their associated processing contexts.

It is also to be appreciated that the particular process steps used in the embodiments described above are exemplary only, and other embodiments can utilize different types and arrangements of processing operations. For example, certain process steps shown as being performed serially in the illustrative embodiments can in other embodiments be performed at least in part in parallel with one another.

It should again be emphasized that the embodiments of the invention as described herein are intended to be illustrative only. Other embodiments of the invention can be implemented utilizing a wide variety of different types and arrangements of information processing systems, networks and devices than those utilized in the particular illustrative embodiments described herein, and in numerous alternative blockchain and non-blockchain processing contexts. In addition, the particular assumptions made herein in the context of describing certain embodiments need not apply in other embodiments. These and numerous other alternative embodiments will be readily apparent to those skilled in the art.

What is claimed is:

1. An apparatus comprising:
a first processing device comprising a processor coupled to a memory;
the first processing device being configured to communicate over at least one network with one or more additional processing devices including at least a second processing device;
the first processing device further comprising:
a first blockchain client; and
a first trusted execution environment;
the first trusted execution environment of the first processing device being configured to establish a first payment channel with a second trusted execution environment of the second processing device;
wherein the first processing device is configured to associate at least one deposit with the first payment channel through execution of a corresponding blockchain transaction via the first blockchain client; and
wherein the first processing device is further configured to utilize the deposit associated with the first payment channel to carry out multiple off-blockchain transactions between the first processing device and at least the second processing device.

2. The apparatus of claim 1 wherein the first payment channel comprises a bidirectional payment channel.

3. The apparatus of claim 1 wherein the blockchain transaction utilized to associate the deposit with the first payment channel is configured to associate a designated amount of cryptocurrency with a first cryptocurrency address of the first trusted execution environment of the first processing device and wherein the first trusted execution environment securely maintains a private key for the cryptocurrency address.

4. The apparatus of claim 1 wherein the first trusted execution environment of the first processing device is configured to interact with the second trusted execution environment of the second processing device in order to securely maintain channel state information for the first payment channel.

5. The apparatus of claim 1 wherein the first processing device is further configured to terminate the first payment channel at a particular point in time in accordance with its current channel state and responsive to the termination of the first payment channel any channel balance is settled through execution of a corresponding blockchain transaction via the first blockchain client.

6. The apparatus of claim 1 wherein carrying out a given one of the multiple off-blockchain transactions between the first processing device and the second processing device further comprises locking the first payment channel, executing a protocol for the first and second processing devices to reach consensus regarding an updated balance for the first payment channel, and then unlocking the first payment channel with the updated balance.

7. The apparatus of claim 1 wherein the first payment channel is part of a chain of payment channels established between trusted execution environments of respective pairs of the processing devices including at least one additional payment channel established between the second trusted execution environment of the second processing device and an additional trusted execution environment of another one of the one or more additional processing devices.

8. The apparatus of claim 7 wherein the deposit associated with the first payment channel is utilized to carry out a given one of the multiple off-blockchain transactions between the first processing device and an n-th one of the processing devices via at least the second processing device, where n is greater than two, and wherein the chain of payment channels comprises n−1 payment channels including the first payment channel.

9. The apparatus of claim 8 wherein carrying out the given one of the multiple off-blockchain transactions between the first processing device and the n-th processing device via at least the second processing device further comprises locking the payment channels of the chain of payment channels between the first processing device and the n-th processing device, executing a protocol for the n processing devices to reach consensus regarding updated balances for respective ones of the payment channels, and then unlocking the payment channels with their respective updated balances.

10. The apparatus of claim 1 wherein in conjunction with establishing the first payment channel with the second trusted execution environment of the second processing device, the first trusted execution environment of the first processing device participates in a remote attestation process with the second trusted execution environment of the second processing device in order to establish a secure link between the first and second trusted execution environments.

11. The apparatus of claim 1 wherein in conjunction with establishing the first payment channel with the second trusted execution environment of the second processing device, the first trusted execution environment of the first processing device generates a first key pair for the first payment channel including a first public key and a first private key, provides the first public key to the second processing device, securely maintains the first private key, and receives a second public key of a second key pair for the first payment channel from the second processing device for which the second trusted execution environment securely maintains a corresponding second private key.

12. The apparatus of claim 1 wherein in conjunction with establishing the first payment channel with the second trusted execution environment of the second processing device, the first trusted execution environment of the first processing device establishes a unique channel identifier for the first payment channel with the second trusted execution environment of the second processing device, provides a first cryptocurrency address to the second trusted execution environment, and receives a second cryptocurrency address from the second trusted execution environment.

13. The apparatus of claim 1 wherein the deposit is associated with the first payment channel in the trusted execution environment of the first processing device responsive to one or more designated conditions being satisfied including approval of the corresponding blockchain transaction by the second trusted execution environment of the second processing device and further wherein association of the deposit with the first payment channel increases a balance of the payment channel by an amount of the deposit.

14. The apparatus of claim 1 wherein the first execution environment of the first processing device is configured to maintain a monotonically increasing counter for the first payment channel with at least the second trusted execution environment of the second processing device and wherein the counter is incremented by the trusted execution environments for each of the multiple off-blockchain transactions carried out between the first processing device and at least the second processing device.

15. The apparatus of claim 8 wherein the first processing device initiates the given one of the multiple off-blockchain transactions at least in part as a payment to the n-th processing device utilizing the deposit associated with the first payment channel and in conjunction with the initialization of the given off-blockchain transaction, the first trusted execution environment transmits to the second trusted execution environment a route payment command identifying an amount of the payment and public keys of respective ones of the trusted execution environments in the chain of payment channels between the first processing device and the n-th processing device.

16. The apparatus of claim 15 wherein in carrying out the given one of the multiple off-blockchain transactions at least in part as a payment to the n-th processing device utilizing the deposit associated with the first payment channel, each of the trusted execution environments in the chain of payment channels between the first processing device and the n-th processing device participates in a plurality of stages of a protocol to reach consensus regarding updated balances for respective ones of the payment channels, the plurality of protocol stages including one or more of a first stage for locking the payment channels, a second stage for signing a settlement transaction, a third stage for promising not to settle pre-payment, a fourth stage for promising to correctly settle post-payment, a fifth stage for updating channel state information, and a sixth stage for unlocking the payment channels.

17. The apparatus of claim 16 wherein the protocol to reach consensus regarding updated balances for respective ones of the payment channels is configured so as to guarantee atomicity for the payment in that the payment either completes successfully and the payment channels settle in a correct post-payment state or the payment does not complete successfully and the payment channels settle in a correct pre-payment state.

18. The apparatus of claim 7 wherein the first processing device and a given one of the other processing devices are coupled via at least two distinct payment paths each comprising at least one payment channel and wherein a first one of the payment paths is terminated by the first processing device without incurring a corresponding blockchain transaction by at least one of: (i) routing any surplus or deficit payment channel balance from the first one of the payment paths into another one of the payment paths; and (ii) disassociating any corresponding deposits that are eligible for disassociation.

19. The apparatus of claim 1 wherein a plurality of payment channels are established between the first trusted execution environment of the first processing device and the second trusted execution environment of the second processing device and wherein the deposit is associated with each of the plurality of payment channels and shared between those payment channels so as to be available for use in conjunction with off-blockchain transactions that are carried out utilizing those payment channels.

20. The apparatus of claim 1 wherein fault tolerance against a failure of the first trusted execution environment is implemented by persisting state of the first trusted execution environment to a secure memory accessible to the first processing device in conjunction with utilization of a monotonically increasing counter to prevent replay attacks.

21. The apparatus of claim 1 wherein fault tolerance against a failure of the first trusted execution environment is implemented by replicating the first trusted execution environment as one or more corresponding remote trusted execution environments in respective ones of one or more independent failure domains.

22. The apparatus of claim 1 wherein the first and second trusted execution environments comprise respective SGX-based secure enclaves of the respective first and second processing devices.

23. A method comprising:
configuring a first processing device to communicate over at least one network with one or more additional processing devices including at least a second processing device;
establishing a first payment channel between a first trusted execution environment of the first processing device and a second trusted execution environment of the second processing device;
associating at least one deposit with the first payment channel through execution of a corresponding blockchain transaction via a first blockchain client of the first processing device; and
utilizing the deposit associated with the first payment channel to carry out multiple off-blockchain transactions between the first processing device and at least the second processing device;
wherein the method is performed by the first processing device interacting with the second processing device, the first and second processing devices each comprising a processor coupled to a memory.

24. The method of claim 23 wherein the first payment channel is part of a chain of payment channels established between trusted execution environments of respective pairs of the processing devices including at least one additional payment channel established between the second trusted execution environment of the second processing device and an additional trusted execution environment of another one of the one or more additional processing devices.

25. A computer program product comprising a non-transitory processor-readable storage medium having stored therein program code of one or more software programs, wherein the program code when executed by a first processing device, the first processing device being configured to communicate over at least one network with one or more additional processing devices including at least a second processing device, causes the first processing device:
to establish a first payment channel between a first trusted execution environment of the first processing device and a second trusted execution environment of the second processing device;
to associate at least one deposit with the payment channel through execution of a corresponding blockchain transaction via a first blockchain client of the first processing device; and
to utilize the deposit associated with the first payment channel to carry out multiple off-blockchain transactions between the first processing device and at least the second processing device.

26. The computer program product of claim 25 wherein the first payment channel is part of a chain of payment channels established between trusted execution environments of respective pairs of the processing devices including at least one additional payment channel established between the second trusted execution environment of the second processing device and an additional trusted execution environment of another one of the one or more additional processing devices.
